(19) United States
(12) Patent Application Publication
(10) Pub. No.: US 2019/0111896 A1
(43) Pub. Date: Apr. 18, 2019

(54) DRYING APPARATUS FOR MOTOR VEHICLES AND VEHICLE WASH INSTALLATION HAVING A DRYING APPARATUS

(71) Applicant: Alfred Kärcher SE & Co. KG, Winnenden (DE)

(72) Inventors: Andreas Seibold, Kernen (DE); Felix Bensing, Stuttgart (DE); Tobias Geltz, Kirchheim unter Teck (DE); Bernd Haberl, Weissach im Tal (DE); Heinz-Peter Ulrichskoetter, Remshalden (DE)

(21) Appl. No.: 16/229,547

(22) Filed: Dec. 21, 2018

Related U.S. Application Data
(63) Continuation of application No. PCT/EP2016/064766, filed on Jun. 24, 2016.

(51) Int. Cl. B60S 3/00; B60S 1/52

(52) U.S. Cl. CPC B60S 3/002; B60S 1/52

(57) ABSTRACT

A drying apparatus for motor vehicles is provided, which is movable in a treatment direction relative to the surface of a motor vehicle to be dried. The drying apparatus includes a plurality of nozzles suppliable with drying air, a nozzle support device, and a holding device holding the nozzle support device. The nozzle support device includes at least two nozzle supporting parts, each holding at least one nozzle, arranged side by side transversely to the treatment direction. The drying apparatus includes an adjusting device for transferring the nozzle supporting parts relative to one another between at least two relative positions in which the parts are oriented at different angles to one another. The relative positions include an angular position in which air flows exiting the nozzles have or form an apex region on the leading side with respect to the treatment direction. A vehicle wash installation is also provided.

### CROSS-REFERENCE TO RELATED APPLICATIONS

This application is a continuation patent application of international application number PCT/EP2016/064766, filed on Jun. 24, 2016, which is incorporated herein by reference in its entirety and for all purposes.

### FIELD OF THE INVENTION

The present invention relates to a drying apparatus for motor vehicles for use in a vehicle wash installation, which drying apparatus is movable in a treatment direction relative to the surface of a motor vehicle to be dried, wherein the drying apparatus comprises a plurality of nozzles to which drying air can be supplied.

Furthermore, the present invention relates to a vehicle wash installation having at least one such drying apparatus.

The vehicle wash installation can be a gantry-type wash installation in which a washing and drying gantry is displaced relative to a stationary motor vehicle. Alternatively, the vehicle wash installation can be a wash line in which the motor vehicle is moved relative to the stationarily positioned drying apparatus. In the case of a gantry-type wash installation, the treatment direction of the drying apparatus is determined by the movement of the washing and drying gantry relative to the motor vehicle. For a wash line, the treatment direction corresponds to the direction that is opposite to the direction of movement of the motor vehicle towards the drying apparatus.

An object underlying the present invention is to provide a drying apparatus of the type mentioned at the outset and a vehicle wash installation in which a better drying result can be achieved for the motor vehicle.

### SUMMARY OF THE INVENTION

In a first aspect of the invention, a drying apparatus for motor vehicles for use in a vehicle wash installation is provided, which drying apparatus is movable in a treatment direction relative to the surface of a motor vehicle to be dried. The drying apparatus comprises a plurality of nozzles which are suppliable with drying air, and further comprises a nozzle support device for the nozzles and a holding device which holds the nozzle support device. The nozzle support device comprises at least two nozzle supporting parts arranged side by side transversely to the treatment direction and at least one nozzle is held directly or indirectly on each nozzle supporting part. The drying apparatus comprises an adjusting device for moving the at least two nozzle supporting parts on the holding device and transferring the nozzle supporting parts relative to one another between at least two relative positions in which the nozzle supporting parts are oriented at different angles to one another, wherein the two or more relative positions comprise at least one angular position in which air flows exiting the nozzles have or form an apex region on the side that is leading with respect to the treatment direction.

In a second aspect of the invention, a vehicle wash installation comprises at least one drying apparatus in accordance with the first aspect.

### BRIEF DESCRIPTION OF THE DRAWINGS

The foregoing summary and the following description may be better understood in conjunction with the drawing figures, of which:

FIG. 1 illustrates, in a schematic side view, a vehicle wash installation in accordance with the invention, in the form of a gantry-type wash installation, comprising a drying apparatus in accordance with the invention, and a motor vehicle to be dried;

FIG. 2 shows, in an enlarged representation, the drying apparatus of FIG. 1;

FIG. 3 illustrates a representation corresponding to FIG. 2, showing the drying apparatus tilted with respect to the vehicle;

FIG. 4 shows a top view of the vehicle wash installation and the motor vehicle in FIG. 1, wherein nozzle supporting parts of the drying apparatus are shown in three different relative positions;

FIG. 5 shows an enlarged partial representation of the drying apparatus, wherein the nozzle supporting parts assume a first angular position;

FIG. 6 shows a representation corresponding to FIG. 5, wherein the nozzle supporting parts assume a straight position;

FIG. 7 shows a representation corresponding to FIG. 5, wherein the nozzle supporting parts assume a second angular position;

FIG. 8 shows a perspective partial representation, partially schematic, of the drying apparatus in FIG. 1;

FIG. 9 shows a perspective partial representation of a second preferred embodiment of the drying apparatus;

FIG. 10 shows, in a top view, a partial representation of the drying apparatus shown in FIG. 9;

FIG. 11 shows, in a side view, a partial representation of the drying apparatus in FIG. 9;

FIG. 12 shows a partial representation of another embodiment of a drying apparatus in accordance with the invention;

FIG. 13 shows, in a top view, a schematic partial representation of another embodiment of a drying apparatus, wherein the nozzle supporting parts assume a straight position;

FIG. 14 shows, in a top view, a schematic partial representation of another embodiment of a drying apparatus, wherein the nozzle supporting parts assume an angular position;

FIG. 15 shows, in a top view, a partial representation of another embodiment of a drying apparatus, wherein the nozzle supporting parts assume a straight position;

FIG. 16 shows the drying apparatus of FIG. 15, wherein the nozzle supporting parts assume an angular position;

FIG. 17 shows, in a top view, a partial representation of another embodiment of a drying apparatus, wherein the nozzle supporting parts assume a straight position;

FIG. 18 shows the drying apparatus of FIG. 17, wherein the nozzle supporting parts assume an angular position;

FIG. 19 shows, in a top view, a partial representation of another embodiment of a drying apparatus, wherein the nozzle supporting parts assume a straight position;

FIG. 20 shows the drying apparatus of FIG. 19, wherein the nozzle supporting parts assume an angular position;

FIG. 21 shows, in a top view, a partial representation of another embodiment of a drying apparatus, wherein the nozzle supporting parts assume a straight position;

FIG. 22 shows the drying apparatus of FIG. 21, wherein the nozzle supporting parts assume an angular position;

FIG. 23 shows, in a top view, a partial representation of another embodiment of a drying apparatus, wherein the nozzle supporting parts assume a straight position;

FIG. 24 shows the drying apparatus of FIG. 23, wherein the nozzle supporting parts assume an angular position;

FIG. 25 shows schematically nozzle supporting parts arranged in an angular position in a further embodiment;

FIG. 26 shows schematically nozzle supporting parts arranged in an angular position in a further embodiment;

FIG. 27 shows schematically nozzle supporting parts arranged in an angular position in a further embodiment;

FIG. 28 shows schematically nozzle supporting parts arranged in an angular position in a further embodiment;

FIG. 29 shows, in a top view, a schematic partial representation of a further embodiment of a drying apparatus, wherein the nozzle supporting parts assume a straight position;

FIG. 30 shows the drying apparatus of FIG. 29, wherein the nozzle supporting parts assume an angular position;

FIG. 31 shows, in a top view, a schematic partial representation of a further embodiment of a drying apparatus, wherein the nozzle supporting parts assume a straight position; and

FIG. 32 shows the drying apparatus of FIG. 31, wherein the nozzle supporting parts assume an angular position.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a drying apparatus for motor vehicles for use in a vehicle wash installation, which drying apparatus is movable in a treatment direction relative to the surface of a motor vehicle to be dried. The drying apparatus comprises a plurality of nozzles which are suppliable with drying air and comprises a nozzle support device for the nozzles and a holding device which holds the nozzle support device. The nozzle support device comprises at least two nozzle supporting parts arranged side by side transversely to the treatment direction and at least one nozzle is held directly or indirectly on each nozzle supporting part. The drying apparatus comprises an adjusting device for moving the at least two nozzle supporting parts on the holding device and transferring the nozzle supporting parts relative to one another between at least two relative positions in which the nozzle supporting parts are oriented at different angles to one another, wherein the two or more relative positions comprise at least one angular position in which air flows exiting the nozzles have or form an apex region on the side that is leading with respect to the treatment direction.

In the drying apparatus in accordance with the invention, provision is made for the at least two nozzle supporting parts, each of which has at least one nozzle held thereto, to be movable by way of the adjusting device. For example, the nozzle supporting parts can be pivoted and/or displaced relative to the holding device. This allows the nozzle supporting parts to be oriented at different angles to each other. Two or more relative positions are possible, in particular wherein the possibility is afforded for the nozzle supporting parts to assume an angular position. In the angular position, the air flows exiting the nozzles comprise or form at least one apex region on the side that is leading with respect to the treatment direction. By virtue of the at least one apex region, liquid on the vehicle surface is blown off outwardly towards the sides during drying. It has been shown in practice that the drying result can thereby be enhanced. In particular, splash-back of liquid droplets out from crevices on the vehicle's surface, as may occur with conventional drying apparatuses, can be largely prevented. By way of example, a wedge shape or a, relative to the treatment direction, convex shape of the air flows is achieved at the apex region by the air flows from the nozzles. This is made possible, for example, by having the two or more nozzle supporting parts oriented relative to each other in the angular position in such a way that the nozzle support device presents a wedge shape or a convex shape. However, where a plurality of nozzle supporting parts are provided, provision may also be made for a plurality of apex regions to be present in the angular positions thereof; as an example, the plurality of nozzle supporting parts are oriented relative to each other in a zigzag relationship.

In the drying apparatus, it is further possible for the nozzle supporting parts to assume at least one further relative position to each other. For example, this allows the angular position to be varied depending on the surface of the vehicle in such a way that an optimum drying result is achieved. For example, the angular position is selected depending on the previously detected contour of the vehicle. Advantageously, it is further possible for the nozzle supporting parts to be transferred to a straight position relative to each other in which they line up with each other transversely or obliquely with respect to the treatment direction. For example, this allows for the drying apparatus to be stowed out of the way when not in use in order to save space.

Thus, in the drying apparatus in accordance with the invention the possibility exists in particular of changing the shape of the front of drying air that impinges on the vehicle. At least one apex region is provided in the angular position of the nozzle supporting parts, whereby the liquid on the motor vehicle's surface can be driven off in an outward direction and a good drying result can be achieved.

In an advantageous embodiment, the drying apparatus is a roof drying apparatus. This is understood to mean a drying apparatus with which surfaces arranged on an upper side of the motor vehicle can be dried, in particular the roof thereof, but of course it is also possible to dry the hood, the windshield, the rear window and a tailgate or a trunk lid. If the drying apparatus is tiltable as will be described below, it can also be utilized for drying the motor vehicle's front or rear end.

It is advantageous for the two or more relative positions to comprise a straight position of the nozzle supporting parts in which the nozzle supporting parts line up with each other and the nozzle support device is of a straight-line or substantially straight-line configuration. Accordingly, the angle between the nozzle supporting parts can be 180° or substantially 180°. For example, when in the straight position, the nozzle supporting parts can be in line with each other transversely to the treatment direction (transverse direction). It is also conceivable for the nozzle supporting parts to be in line with each other obliquely to the treatment direction and obliquely to the transverse direction when they assume the straight position. The nozzle support device can thereby assume an orientation that is diagonally across the vehicle, and liquid can be driven off obliquely across the vehicle from one side to the other.

By way of example, in the straight position of the nozzle supporting parts, the front of drying air formed by the air flows of the nozzles is planar, without an apex region being formed. In the straight position of the nozzle supporting parts with nozzle supporting parts oriented transversely to the treatment direction, the drying apparatus can be stowed away to a more space-saving configuration, as has already been mentioned. A drying apparatus that is tiltable about an axis transverse to the treatment direction can thereby also be pivoted more closely past the motor vehicle's surface. This has proved to be advantageous, for example, at transitions between vehicle surfaces oriented at an angle to one another, for example in the area of the transition from the hood to the windshield.

It is advantageous for the two or more relative positions to comprise a plurality of angular positions in which the nozzle supporting parts are oriented at different angles to one another, wherein air flows exiting the nozzles have or form in each case at least one apex region on the side that is leading with respect to the treatment direction. This enables greater versatility in adapting the drying apparatus to the shape of the motor vehicle and allows an optimum drying result to be achieved. In the case of nozzle supporting parts that form a wedge, the angular positions differ by different wedge angles between the nozzle supporting parts in particular.

“Angle” in this case refers to the smaller of the angles formed between the nozzle supporting parts.

Preferably, the nozzle supporting parts can be transferred continuously or in steps between the two or more relative positions, in particular between two or more angular positions, by way of the adjusting device. Advantageously, any desired number of angular positions may be provided in which the nozzle supporting parts are oriented at different angles to each other. For nozzle supporting parts arranged in a wedge-shape, these constitute different wedge angles.

Adjacent nozzle supporting parts can be connected together for pivotal movement and/or displacement on a joint. Preferably, the joint is arranged on an end side of a nozzle supporting part facing towards the respective adjacent nozzle supporting part.

It is advantageous for the treatment direction to be reversible, in particular where the drying apparatus is used in a gantry-type wash installation. It is advantageous if, by way of the adjusting device, the nozzle supporting parts are transferable relative to one another between at least two relative positions in which the nozzle supporting parts are oriented at different angles to one another, wherein at least one angular position is provided in which air flows exiting the nozzles have or form an apex region on the side that is leading with respect to the reverse treatment direction. It is thereby possible that, when the treatment direction is reversed, the nozzle supporting parts can also be pivoted and/or displaced relative to the holding device in the opposite direction in order that even when the gantry is moved in the reverse treatment direction, an angular position can be achieved in which the air flows have or form at least one apex region. The drying apparatus is thereby rendered highly versatile.

It is advantageous for the drying apparatus to comprise a detection device for detecting the contour of the motor vehicle and a control device coupled to the detection device and to the adjusting device, wherein the nozzle supporting parts assume the at least one angular position depending on the detected contour. Operation of the drying apparatus can thereby be adapted with regard to an optimum drying result. The contour of the vehicle can be detected before or during the drying process. By way of example, the contour is already detected prior to or during a wash process. Depending on the contour, the control device can control the adjusting device in such a way that the nozzle supporting parts assume an angular position such that the front of the air flows is optimally adjusted to the surface that is to be dried. It is also conceivable for the nozzle supporting parts to be transferred to the straight position as already mentioned. This is advantageous, for example, when drying a vehicle's front end or a rear end of the vehicle.

It is advantageous if, in a transition area at which surfaces of the motor vehicle meet at an angle, the nozzle supporting parts assume the straight position relative to each other or assume an angular position in which they are oriented to each other at a greater angle than when at a distance from the transition area. This has already been discussed. If surfaces of the motor vehicle meet at an angle (different from 180°), the nozzle supporting parts are transferred to the straight position or to such an angular position that the drying apparatus can better be moved more closely past the vehicle. At a distance from the transition area, the angle between the nozzle supporting parts can be made smaller by, for example, a more pronounced wedge shape, whereby liquid can be driven off outwardly in an enhanced manner.

In the at least one angular position of the nozzle supporting parts, in particular where only two nozzle supporting parts are provided, the drying apparatus can have a wedge-like shape in the treatment direction. The front of the air flows impinging on the vehicle can also be formed with a wedge shape having the at least one apex area.

In a different embodiment, provision may be made for the nozzle support device to comprise more than two nozzle supporting parts which, in the at least one angular position, are oriented with respect to each other in such a way that the nozzle support device has a convex or trapezoidal shape in the treatment direction. For example, in the at least one angular position, the nozzle supporting parts are arranged in the shape of an arc and the nozzle support device has a convex shape. The front of the air flows can also have a convex shape having the at least one apex region. A trapezoidal shape of the nozzle support device is achieved, for example, by having two or more nozzle supporting parts oriented obliquely with respect to the treatment direction and inclined towards each other and having at least one nozzle supporting part therebetween oriented transversely to the treatment direction. The front of the air flows can also be trapezoidal with at least one apex region.

In a different embodiment, provision may be made for the nozzle support device to comprise more than two nozzle supporting parts which, in the at least one angular position, assume a zigzag arrangement with respect to each other. As has already been mentioned, this provides the possibility of forming a plurality of apex regions of the air flows in the treatment direction. The front of the air flows can also be zigzag-shaped.

The adjusting device can be configured in a variety of ways. For example, at least one of the following configurations is conceivable: mechanical, electrical, pneumatic and/or hydraulic.

In an advantageous implementation of the drying apparatus, the adjusting device comprises at least one, preferably pneumatic, piston-cylinder unit which engages the holding device and, directly or indirectly, at least one nozzle supporting part. The piston-cylinder unit forms an actuator of the adjusting device on change in length of which the nozzle supporting part can be pivoted and/or displaced relative to the holding device.

It has proved to be advantageous for the nozzle supporting parts to be configured for pivotal and/or displacement movement on the holding device via the adjusting device, wherein corresponding bearing elements of the nozzle supporting parts and of the holding device cooperate. For example, the bearing elements are arranged on the nozzle supporting parts and on the holding device on an outer side or end side thereof, transversely to the treatment direction.

Provision may be made for cooperating bearing elements of a respective nozzle supporting part and the holding device to form a pivot bearing.

It has proved to be advantageous for a respective pivot bearing formed by the cooperating bearing elements to be variably positionable for displacing the nozzle supporting parts relative to one another when the nozzle supporting parts are transferred to the at least one angular position. A displacement movement can thereby be achieved in addition to the pivotal movement. This is advantageous because with increasing pivoting of the nozzle supporting parts relative to the holding device (accompanied by a decreasing angle between the nozzle supporting parts), a distance between the nozzle supporting parts in the apex region may increase. Through the possibility of the nozzle supporting parts being displaced relative to each other by movement of the pivot bearings, an increase in distance in the apex region can be avoided. Ideally, the nozzle supporting parts are spaced at a constant distance from each other in the apex region, regardless of the pivot angle relative to the holding device.

Preferably, the cooperating bearing elements comprise a bearing pin and a guide therefor, wherein the bearing pin is displaced in the guide when the nozzle supporting parts are pivoted relative to the holding device. The guide is for example an elongated hole oriented transversely to the treatment direction, in which elongated hole the bearing pin can be displaced.

Provision may be made for the bearing pin to be arranged on the nozzle supporting part and for the guide to be arranged on the holding device; however, this may also be reversed.

It is advantageous for a respective constrained guide to be provided which guides the movement of the nozzle supporting part when the nozzle supporting part is pivoted and displaced relative to the holding device. A defined pivotal-displacement movement of the nozzle supporting parts relative to the holding device can thereby be achieved.

The respective constrained guide preferably comprises a guide track and a guide element engaging therein.

For example, the guide track is arranged on the holding device and the guide element is arranged on the nozzle supporting part; however, this can also be reversed.

It has proved to be advantageous for the guide track to be configured in a substantially W or V shape. For example, the guide track has arcuate sections which, in a sense, form the “sides” of the W or V shape. For example, this allows for the guide element to be guided in the case that the nozzle supporting parts can be pivoted in the treatment direction as well as, as previously mentioned, in the reverse treatment direction. The nozzle supporting parts can be restraint-guided in both pivotal movements. Preferably, the guide track has, in the center thereof, i.e., in a sense in the “center” of the W or V shape, a bend or a recess with which or in which the guide element can in a sense latchingly engage. This is the case when, for example, the nozzle supporting parts described in the foregoing assume the straight position, which is thereby rendered particularly well defined.

Another advantageous embodiment provides for the respective constrained guide to comprise a joint member which is articulated to the holding device and to the nozzle supporting part. The joint member limits the possibility of the nozzle supporting part moving relative to the holding device. As a result, the combined pivotal and displacement movement can thereby be ensured.

It has proved advantageous for an actuator of the adjusting device, in particular a piston-cylinder unit, to engage the joint member and the holding device. Preferably, the actuator can be fixed to the joint member in one of a plurality of different predefined positions. Depending on the position in which the actuator engages the joint member, the range of movement of the nozzle supporting part relative to the holding device can thereby be predetermined, for example.

It is advantageous for the drying apparatus to comprise a coupling device for coupling the nozzle supporting parts to each other, wherein a movement of one nozzle supporting part relative to the holding device can be transferred to the other nozzle supporting part and the latter can also be moved relative to the holding device. On the one hand, this gives the possibility of a coordinated, synchronized movement of the nozzle supporting parts relative to the holding device to be performed. Also there is the possibility that both nozzle supporting parts can be moved with only one actuator of the adjusting device.

It is therefore advantageous for the adjusting device to engage only one of the nozzle supporting parts in order to move these relative to the holding device.

An advantageous embodiment of the drying apparatus provides for the coupling device to comprise a joint connecting the nozzle supporting parts with each other, via which joint the nozzle supporting parts are pivotably connected with each other. Preferably, the joint is arranged on a respective end side of the nozzle supporting parts that faces towards the other nozzle supporting part. In particular, this also allows the spacing of the nozzle supporting parts to be kept constant during the combined pivotal-displacement movement. This ensures that the apex region is maintained even at different angular positions of the nozzle supporting parts.

The same advantage can be achieved in another advantageous embodiment by the coupling device comprising a rolling body on each of the nozzle supporting parts, which rolling bodies roll on one another when the nozzle supporting parts are pivoted to the at least one angular position, preferably wherein the rolling bodies are arranged on respective end sides of the nozzle supporting parts facing towards one another.

The respective rolling body in the present case can be a toothed wheel or a toothed wheel segment. Toothed wheels or toothed wheel segments can mesh with each other.

Furthermore, the above-mentioned advantage can be achieved for example in a preferred embodiment in which the coupling device comprises a joint member which is articulated to the nozzle supporting parts, preferably on respective end sides of the nozzle supporting parts facing towards each other. For example, the joint member comprises a guide in which guide elements articulated to the nozzle supporting parts engage.

In another advantageous embodiment, provision may be made for the coupling device to comprise a joint member which is articulated to the joint members of the respective constrained guide.

An advantageous embodiment of the drying apparatus provides for the adjusting device to comprise a respective rolling drive for the nozzle supporting parts having a driving track displaceable on the holding device and a rolling body rolling on the driving track and fixed directly or indirectly to the nozzle supporting part. The rolling body and hence the respective nozzle supporting part can be pivoted relative to the holding device by displacing the driving track.

In the present case, the rolling drive can be a rack-and-pinion drive, wherein the driving track is a toothed rack and the rolling body is a toothed wheel or toothed wheel segment meshing therewith.

Provision may be made for the rolling body to be connected to a respective joint member of the respective constrained guide in rotationally fixed relation therewith. Displacement of the driving track rotates the joint member of the constrained guide which joint member is articulated to the holding device and to the respective nozzle supporting part. The aforementioned pivotal and displacement movement can thereby be implemented.

It is advantageous for the adjusting device to comprise a common drive wheel with which both driving tracks associated with the nozzle supporting parts can be driven. This saves the need for separate adjusting devices for the nozzle supporting parts.

An advantageous embodiment of the drying apparatus provides for the nozzle supporting parts each to be articulately connected to the holding device via two joint members of different lengths which are articulated to the holding device and to the respective nozzle supporting part in spaced relation to each other. Each nozzle supporting part is associated with two joint members of different lengths. The respective pivot points on the holding device and on the nozzle supporting part are spaced apart from each other. The holding device and a respective nozzle supporting part as well as the two joint members form a four-bar linkage. It is thereby possible to implement a pivotal movement of the nozzle supporting part and a movement in the direction towards the other nozzle supporting part at the same time.

Another advantageous embodiment of the drying apparatus provides for the nozzle supporting parts in each case to be pivotably connected to the holding device, wherein two curved guide tracks arranged in spaced relation to one another and guide elements engaging therein are provided for each nozzle supporting part. For example, the guide tracks are formed on the holding device and the nozzle supporting part comprises the guide elements; however, the reverse case is also possible. This provides another way of implementing a superposed pivotal and displacement movement of one nozzle supporting part relative to the other nozzle supporting part.

In practice, it has proved advantageous for the holding device to comprise, associated with a respective nozzle supporting part, a holding part on which the respective nozzle supporting part is movably supported as well as a carrier holding the holding parts.

Advantageously, the drying apparatus comprises a lifting device for lifting, relative to the motor vehicle, the holding device having a nozzle support device held thereon and/or a tilting device for tilting, relative to the motor vehicle, the holding device having a nozzle support device held thereon. In particular, a control device is provided for controlling the lifting device and/or the tilting device. For example, the aforementioned carrier of the holding device can be oriented transversely to the treatment direction and can be held to further carriers for height adjustment by the lifting device and/or for tilting movement about an axis transverse to the treatment direction by the tilting device.

As used herein, “transverse direction” refers to a direction transverse to the treatment direction and in particular parallel to a supporting surface of the motor vehicle.

In an embodiment that is simple in construction, the aforementioned holding parts and/or nozzle supporting parts are fabricated of a sheet material which is for example made of a metal and can be folded for stiffening.

Advantageously, the nozzles of the drying apparatus may be or comprise the following:
flat jet nozzles which form an air flow that spreads out in a fan shape in substantially one plane; and/or
circular jet nozzles which form air flow shapes including cylindrical, hollow-cylindrical (along, for example, the curved surface of a cylinder), conical, truncated cone or hollow-conical; and/or
slotted nozzles, wherein exactly one slotted nozzle can be provided on each nozzle supporting part; and/or
nozzles which form an air flow in a curved surface area (of for example a convex or concave shape in the treatment direction) that can widen or maintain a constant width.

A plurality of nozzles can be held on each of the nozzle supporting parts. Preferably, the nozzles are arranged side by side next to one another on the nozzle supporting part, in particular if they are flat jet nozzles. The nozzles can be positioned equidistantly to each other.

In an advantageous embodiment of the drying apparatus, provision may be made for the nozzles to be arranged on the nozzle supporting parts such that in the at least one angular position thereof, the air flows form a convex or concave shape in the treatment direction. For example, flat jet nozzles are provided whose air flows are not oriented in a coplanar relationship but at an angle relative to each other. A convex or a concave front of the air flows can thereby be achieved in the treatment direction, wherein at least one apex region is present in the angular position of the nozzle supporting parts in each case.

In particular, the plurality of nozzles on the nozzle supporting parts are flat jet nozzles and/or circular jet nozzles.

Provision may be made for the plurality of nozzles to be held separately from one another on the nozzle supporting part and to have drying air supplied thereto by a blower device of the drying apparatus via respective ducts.

In an advantageous embodiment, provision is made for a duct for drying air to be held on a respective nozzle supporting part or for the respective nozzle supporting part to comprise such a duct or to be formed by a duct which has the plurality of nozzles on the outlet side thereof and can have drying air supplied thereto at an inlet side thereof by a blower device. This saves the need for a separate duct for each nozzle. The duct having the nozzles arranged thereon can form a nozzle supporting part. The nozzles can be arranged on the duct in a variably positionable manner.

The extension of a duct of the nozzle supporting part or of a duct on the nozzle supporting part can define the direction or extension of the nozzle supporting part. Therefore, in advantageous embodiments, an angle between the nozzle supporting parts can also be regarded as the angle between the ducts.

Preferably, the drying apparatus comprises a blower device having at least one blower which supplies the nozzles with drying air.

It has proved advantageous for the blower device to comprise a blower which has two or more nozzles associated therewith. Alternatively, provision may be made for each nozzle to have a separate blower of the blower device associated therewith.

Advantageously, the blower device is held to the holding device and preferably adjustable in height and/or tiltable about an axis transverse to the treatment direction together the holding device. This facilitates the routing of hoses or ducts in order to supply the drying air to the nozzles.

Provision may be made for each nozzle supporting part to have arranged thereon a slotted nozzle extended in the longitudinal direction thereof.

It is advantageous for the drying apparatus to comprise a detection device for detecting the contour of the motor vehicle and a control device coupled to the detection device and to the lifting device, wherein the drying apparatus can be brought to a distance from the surface of the motor vehicle at which air flows of the plurality of nozzles superimpose one another above the surface. This ensures coverage of all areas of the surface by drying air. The drying result can thereby be enhanced.

In particular when a plurality of nozzles is provided on the nozzle supporting parts, it is advantageous for the nozzle supporting parts and the nozzles held thereto to be symmetrically configured relative to one another and arranged on the drying apparatus.

It has proved advantageous for a circular jet nozzle to be arranged on at least one nozzle supporting part on a side thereof facing towards an adjacent nozzle supporting part so that in the angular position of the nozzle supporting parts at least one air flow from a circular jet nozzle can be provided in the apex region.

Furthermore, at least one circular jet nozzle can be arranged on the holding device in order to provide a circular jet in the apex region.

In an advantageous embodiment of the drying apparatus, provision may be made for nozzles to be held to a respective nozzle supporting part in a variably positionable manner. In particular, the possibility is afforded for each nozzle to be pivoted and/or displaced individually on the nozzle supporting part. A pivot axis may be arbitrary; for example, it is an axis defined by the nozzle.

As has already been mentioned, the invention further relates to a vehicle wash installation. A vehicle wash installation in accordance with the invention comprises at least one drying apparatus for motor vehicles for use in a vehicle wash installation. The drying apparatus is movable in a treatment direction relative to the surface of a motor vehicle to be dried. The drying apparatus comprises a plurality of nozzles which are suppliable with drying air and further comprises a nozzle support device for the nozzles and a holding device which holds the nozzle support device. The nozzle support device comprises at least two nozzle supporting parts arranged side by side transversely to the treatment direction and at least one nozzle is held directly or indirectly on each nozzle supporting part. The drying apparatus comprises an adjusting device for moving the at least two nozzle supporting parts on the holding device and transferring the nozzle supporting parts relative to one another between at least two relative positions in which the nozzle supporting parts are oriented at different angles to one another, wherein the two or more relative positions comprise at least one angular position in which air flows exiting the nozzles have or form an apex region on the side that is leading with respect to the treatment direction.

The advantages that have already been mentioned in the context of describing the drying apparatus in accordance with the invention can also be achieved with the vehicle wash installation. In this respect, reference may be had to what has been described above.

Advantageous embodiments of the vehicle wash installation result from advantageous embodiments of the drying apparatus.

As has already been mentioned, the vehicle wash installation can be a gantry-type wash installation. Alternatively, it can be a wash line.

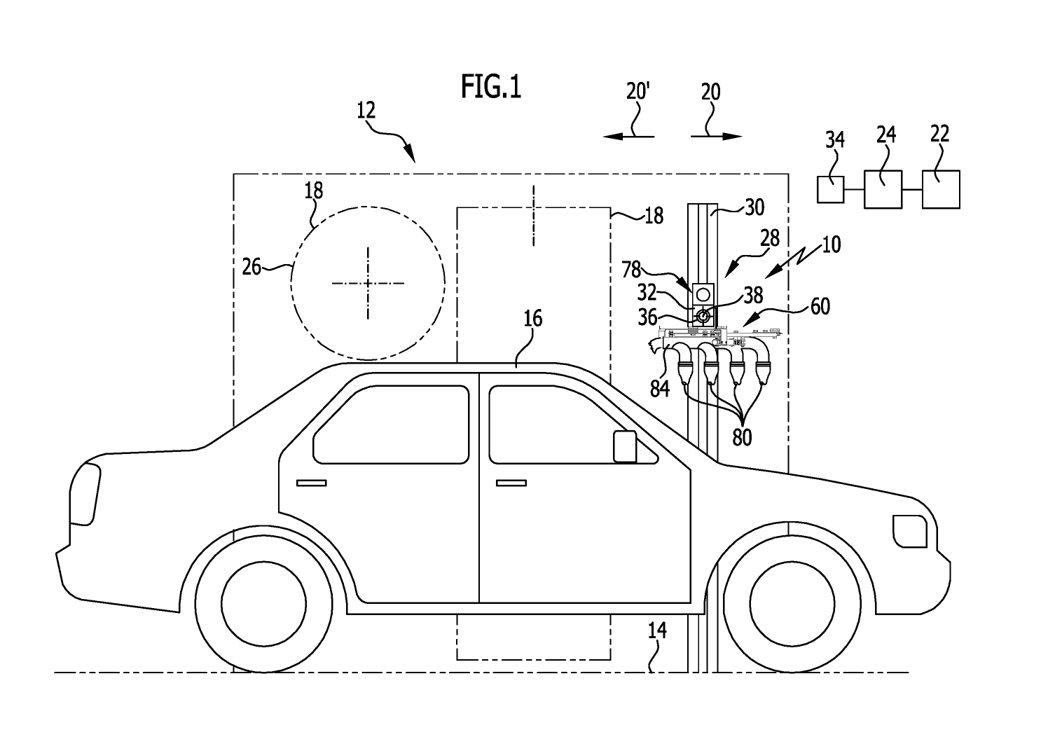

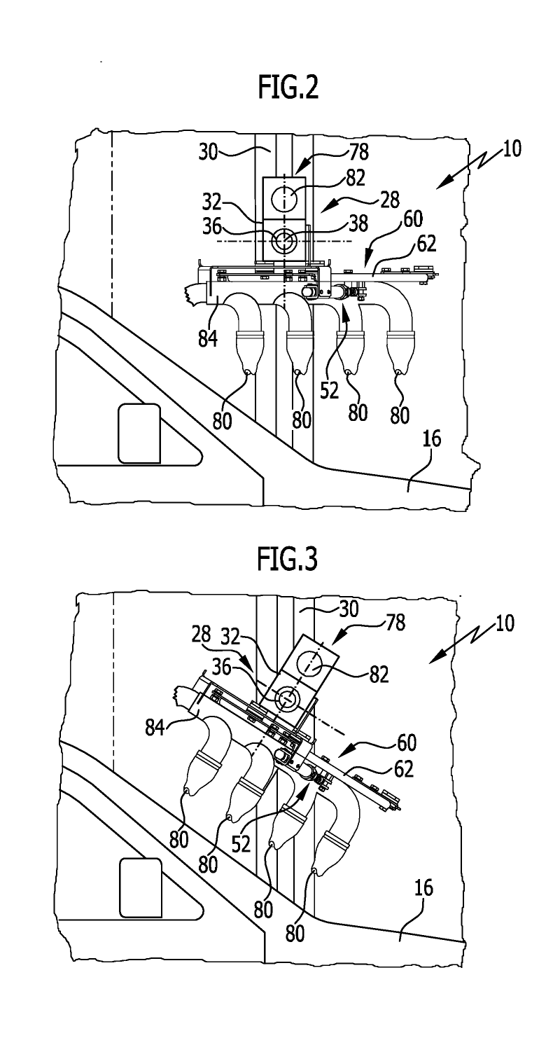

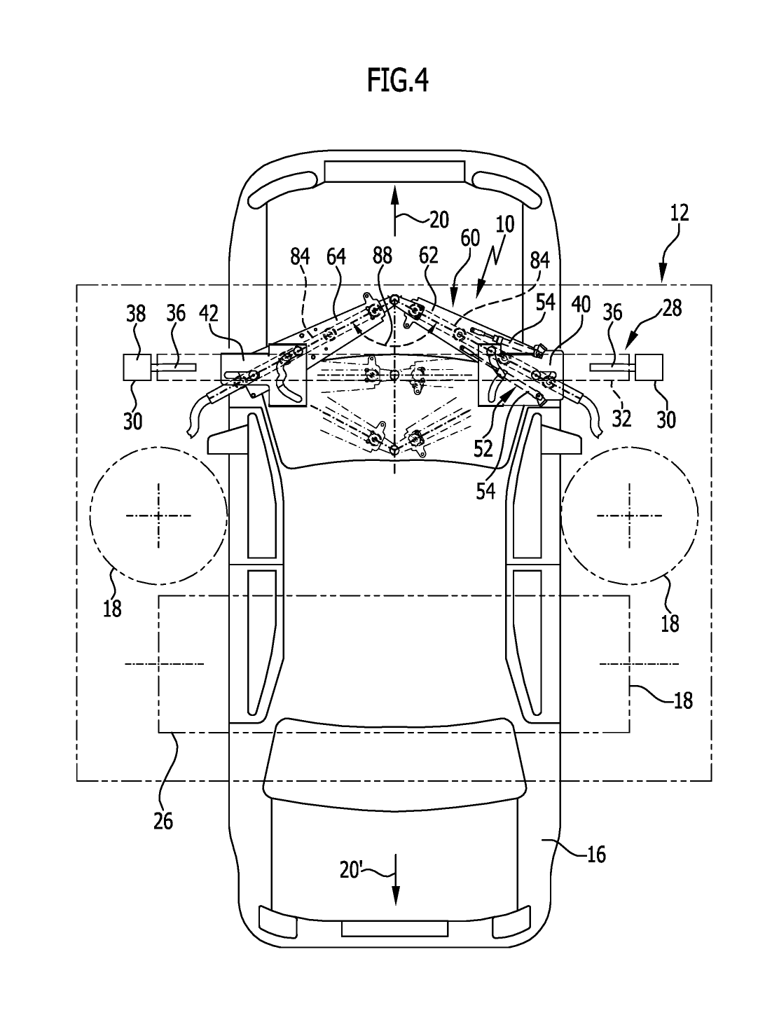

FIGS. 1 to 8 illustrate a first advantageous embodiment of a drying apparatus in accordance with the invention, designated by the reference numeral 10, for use in a vehicle wash installation 12 in accordance with the invention, schematically shown in FIGS. 1 and 4. By way of the vehicle wash installation 12, a motor vehicle 16 positioned on a supporting surface 14 can first be cleaned using cleaning units 18 and then dried using the drying apparatus 10.

The vehicle wash installation 12 is configured as a gantry-type wash installation which is moved over the motor vehicle 16 in multiple passes, wherein the drawing shows the wash gantry of the vehicle wash installation 12 as being in a treatment direction 20. In the present case, the wash gantry is moved in the treatment direction 20 from the rear to the front of the motor vehicle 16 in order to dry same. The treatment direction can also be reversed in order for the motor vehicle 16 to be capable of being dried from the front to the rear.

The drying apparatus 10 is a roof drying apparatus for drying upwardly facing surfaces of the vehicle 10. Although these include the roof in particular, the drying apparatus 10 can also be used to dry the hood, the windshield, the rear window, the trunk lid and the front and rear end of the vehicle 16.

The drying apparatus 10 comprises a detection device 22, schematically represented in FIG. 1, which is coupled to a control device 24. The control device 24 serves to control the drives, which will be described hereinafter, of the drying apparatus 10.

The detection device 22 allows the contour of the vehicle 16 to be detected and the corresponding information to be used as a basis for the drying process. As an example, the detection device 22 detects the contour prior to or during a wash process. To this end, for example, the contour can be derived from the motor current that is required by a roof brush 26. Light barriers may also be employed. Contour detection determines, for example, how different surfaces of the vehicle 16 are oriented with respect to each other. The areas of transition between surfaces angularly oriented to each other can be determined, such as at the transition from the hood to the windshield, thence to the roof, thence to the rear window and thence to the trunk lid.

The drying apparatus 10 has a holding device 28 arranged on the wash gantry, said holding device 28 comprising two vertical beams 30 and a cross beam 32. The cross beam 32 is shown only schematically or by its contour in the drawing and is hidden from view in FIGS. 5 and 7. The vertical beams 30, which can for example be constituent parts of the wash gantry, are positioned in spaced relation to each other and are connected together via the cross beam 32. The term “transverse direction” refers to a direction transverse to the treatment direction 20 and parallel to the supporting surface 14.

The drying apparatus 10 comprises a lifting device 34 for raising and lowering the cross beam 32 at the vertical beams 30. The lifting device 34 can be controlled by the control device 24.

The drying apparatus 10 further comprises a tilting device 36 (FIG. 4). Via the tilting device 36, the cross beam 32 can be tilted relative to the vertical beams 30 about an axis 38 running in the transverse direction. The tilting device 36 can be controlled by the control device 24.

Depending on the contour of the vehicle 16 as determined, the lifting device 34 and the tilting device 36 can be controlled in order for the nozzles, to be described hereinafter, of the drying apparatus 10 to follow the contour of the vehicle 16 in order to achieve as good a drying result as possible.

In addition to the cross beam 32, the holding device 28 comprises two holding parts 40, 42. The holding parts 40, 42 are spaced apart from each other in the transverse direction and are fixed to the cross beam 32. For example, the holding parts 40, 42 are fabricated using a folded sheet-like material such as a metal sheet material.

Formed on each holding part 40, 42 is a bearing element 44 for a combined pivotal and displacement movement of the nozzle supporting parts which are mentioned hereinafter. The bearing element 44 is a guide 46 configured as an elongated hole oriented in the transverse direction.

Furthermore, each holding part 40, 42 has a guide track 48 of a constrained guide 50 formed thereon for cooperating with a guide element of the nozzle supporting parts. The guide track 48 on the holding part 40 is essentially formed in the form of a V having two arcuate guide track sections which converge towards each other and, in a sense, meet in the center of the V. The guide track 48 of the holding part 40 has a bend in the center. The guide track 48 is arranged on the holding part 40 such that the V opens in a direction towards the holding part 42.

The guide track 48 of the holding part 42 is of a substantially W-shaped configuration and arranged such that the W opens in a direction towards the holding part 40. The guide track 48 comprises two meeting curved guide track sections so that the W-shaped guide track 48 also has a bend in the center thereof.

The drying apparatus 10 further comprises an adjusting device 52 which can be controlled by the control device 24. In the present case, the adjusting device 52 comprises two actuators 54 configured as pneumatic piston-cylinder units 56 and 58 respectively. These can have a pressure applied to them by pneumatic equipment, not shown.

The piston-cylinder units 56, 58 have a first end thereof fixed to the holding part 40, on opposite sides of the latter's guide 46.

The drying apparatus 10 comprises a nozzle support device 60 which is held to the holding device 28 and which in the present case comprises two nozzle supporting parts 62, 64 in particular. The nozzle supporting part 62 is associated with and movably supported on the holding part 40. The nozzle supporting part 64 is associated with and movably supported on the holding part 42. The nozzle supporting parts are, for example, fabricated using folded sheet-like materials such as a metal sheet material.

As shown in FIGS. 5 to 8 in particular, the nozzle supporting parts are of substantially elongated configuration while being slightly conically tapered; however, a straight-line construction is also conceivable.

The nozzle supporting parts 62, 64 comprise bearing elements 66 for cooperating with the bearing elements 44. In the present case, the bearing elements 66 are bearing pins 68 which together with the guide 46 form a pivot bearing 70. With the configuration of the guide 46 as an elongated hole, the pivot bearing 70 is variably positionable along the transverse direction. The nozzle supporting parts 62, 64 can thereby pivot relative to the holding parts 40, 42 respectively and simultaneously displace in the transverse direction by reason of the variable-position pivot bearings 70.

The constrained guide 50 comprises guide elements 72 on the nozzle supporting parts 62, 64 which engage in the guide tracks 48 of the holding parts 40 and 42. In the pivotal and displacement movement of the nozzle supporting parts 62, 64 on the holding parts 40, 42, the movement is thereby clearly defined by reason of the constrained guide 50.

The piston-cylinder units 56, 58 engage the nozzle supporting part 62 at their respective end facing away from the holding part 40. Depending on a change in length of the piston-cylinder units 56, 58, as will be explained in more detail below, pivoting of the nozzle supporting parts 62, 64 with simultaneous displacement is thereby possible.

The drying apparatus 10 comprises a coupling device 74. This provides the possibility of transferring a movement of the nozzle supporting part 62 to the nozzle supporting part 64. The latter can thereby be caused to move without the need for an actuator of the adjusting device 52 having to engage the holding part 42 and the nozzle supporting part 64.

In the present case, the coupling device 74 comprises a joint 76 formed between the nozzle supporting parts 62, 64. The joint 76 is arranged on the nozzle supporting parts 62, 64 on end sides thereof facing towards the respective other nozzle supporting part 64, 62 in each case.

A joint axis of the joint 76 runs transversely to the treatment direction 20 and to the transverse direction. The same applies analogously to the pivot axes defined by the bearing pins 68.

The drying apparatus 10 comprises a blower device 78 and a plurality of nozzles 80 for applying drying air to the surface of the vehicle 16. The blower device 78 (FIGS. 1 to 3) is preferably fixed to the holding device 28 and in particular to the cross beam 32 thereof. This facilitates the routing of any hoses or ducts to supply the nozzles 80 with drying air. The blower device 78 comprises at least one blower 82, wherein in the present case, for example, two blowers 82 may be provided, with one blower 82 being associated with the nozzles 80 of each nozzle supporting part 62, 64.

The nozzles 80 are held indirectly on the nozzle supporting parts 62, 64. To this end, the drying apparatus 10 has a duct 84 associated with each nozzle supporting part 62, 64, said duct 84 having nozzles 80 arranged on the outlet side thereof. In the present case, four nozzles 80 are arranged on the outlet side of each duct 84. On the inlet side, the duct 84 is connected to a blower 82 via a hose conduit, not shown in the drawing.

The ducts 84 are of elongated configuration and extend in a longitudinal direction of the nozzle supporting parts 62 and 64. An angle between the ducts 84 thereby also corresponds to an angle between the nozzle supporting parts 62, 64. Duct sections branch off from a main duct in order to supply a respective nozzle 80 arranged on the end side. The ducts 84 thereby have an approximately comb-like shape.

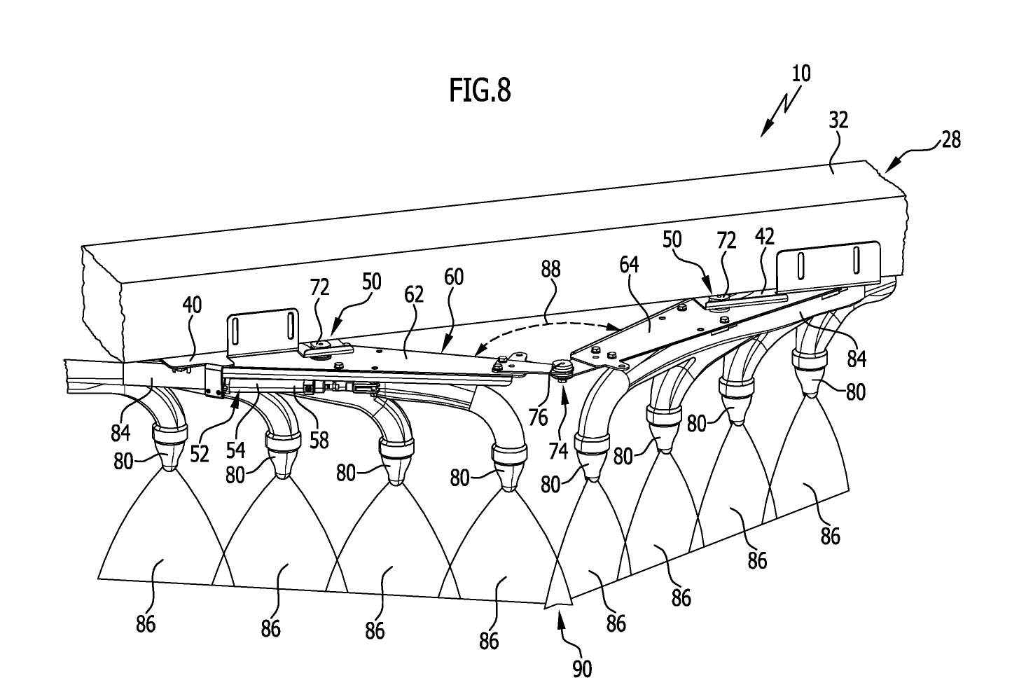

In the drying apparatus 10, the nozzles 80 are flat jet nozzles, each of which provides an air flow 86 that spreads out in a fan shape. An opening angle of the air flow 86 at the nozzle 80 is approximately 45° to 60° for example. Air flows 86 provided by the nozzles 80 of a duct 84 lie substantially on one plane (FIG. 8).

The duct 84 is connected to the respective nozzle supporting part 62, 64 by, for example, a screwed connection so that it can easily be removed for maintenance purposes. The duct 84 is arranged on the nozzle supporting part 62, 64 on the side thereof opposite the holding part 40 and 42 respectively.

In the following, the operation and the advantages of the drying apparatus 10 and the vehicle wash installation 12 will be discussed in more detail with reference to FIGS. 4 to 8 in particular.

The nozzle supporting parts 62, 64 can assume different relative positions in which they are oriented relative to each other at different angles. “Angle” in the present case refers to an angle 88, refer to FIGS. 5, 6 and 8, formed between the nozzle supporting parts 62, 64 on the side thereof facing away from the treatment direction 20. This is the smaller of the two angles between the nozzle supporting parts 62, 64.

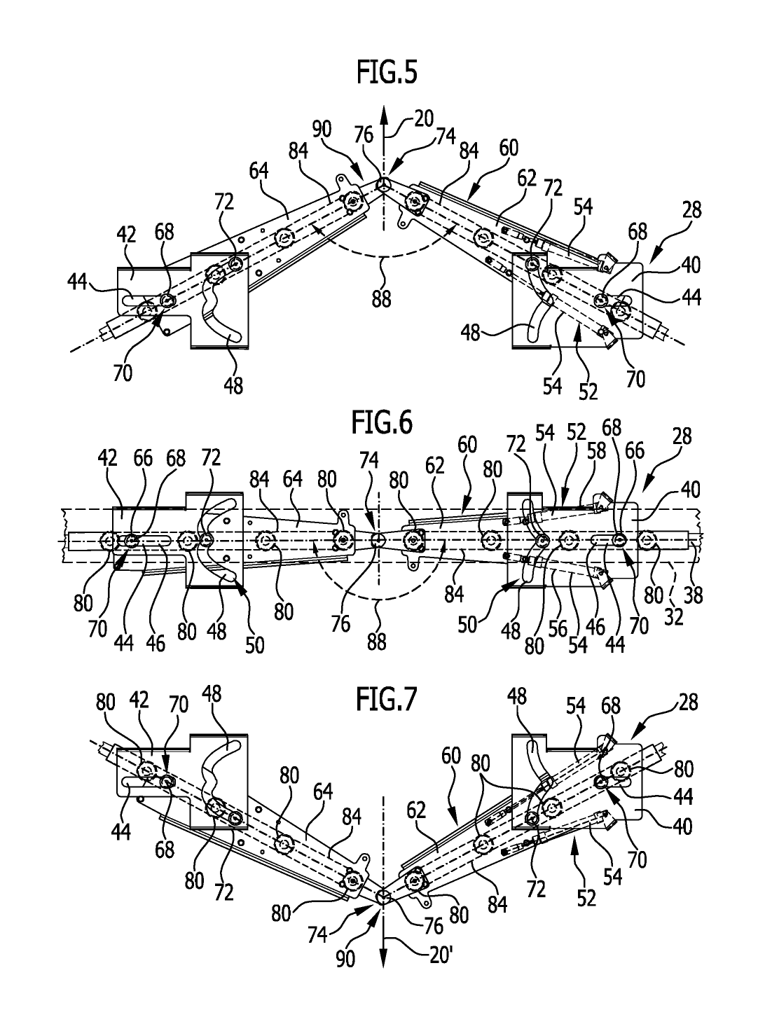

A first relative position of the nozzle supporting parts 62, 64 is a straight position, this being illustrated in FIG. 6. In the straight position, the nozzle supporting parts 62, 64 line up with one another so that the nozzle support device 60 is of substantially straight-line configuration. The angle 88 between the nozzle supporting parts 62, 64 is 180°. The straight position of the nozzle supporting parts 62, 64 is particularly well defined because of the presence of the bends in the guide tracks 48 of the constrained guides 50. When in the straight position, the nozzle supporting parts 62, 64 are oriented transversely to the treatment direction 20.

In particular, the straight position is taken when the drying apparatus 10 is to be stowed out of the way when not in use in order to save space. The straight position of the nozzle supporting parts 62, 64 has also proved to be particularly advantageous when the front or the rear of the motor vehicle 16 is to be dried.

In particular, a straight position is also advantageous when the cross beam 32 is to be pivoted at areas of transition between surfaces of the vehicle 16 that are arranged at an angle to one another, wherein the nozzles 80 are arranged close to the surface of the motor vehicle. Because of the straight position, less space is needed for pivoting so that the nozzles 80 can be moved past the surface of the vehicle 16 as close as possible for achieving an advantageous drying result, yet the space requirement for pivoting the cross beam 32 is relatively low.

The nozzle supporting parts 62, 64 can be transferred to a further relative position by way of the adjusting device 52; of these positions, one is illustrated in FIG. 5 and hereinafter referred to as an angular position. In particular, a plurality of angular positions are provided in which the nozzle supporting parts 62, 64 are oriented at an angle 88 less than 180°. For example, the nozzle supporting parts 62, 64 can be angled relative to each other such that the angle 88 is up to approximately 100°. Each nozzle supporting part 62, 64 is thereby angled by an amount of up to 40° relative to the transverse direction. In an implementation of the drying apparatus 10 in practice, an angle 88 of approximately 110° has been shown to be advantageous.

For transferring the nozzle supporting parts 62, 64 to the angular position, the control device 24 controls the adjusting device 52 to extend the piston-cylinder unit 56. The nozzle supporting part 62 thereby pivots on the pivot bearing 70 relative to the holding part 40. At the same time, the nozzle supporting part 62 is displaced in the transverse direction towards the nozzle supporting part 64 by the pivot bearing 70 displacing in the elongated hole guide 46 and the guide element 72 travelling through the guide track 48 on the holding part 40.

By virtue of the coupling device 74 via the joint 76, the nozzle supporting part 64 pivots on the pivot bearing 70 relative to the holding part 42. In addition, displacement occurs in a direction towards the nozzle supporting part 62 as a result of the displacement of the pivot bearing 70 in the elongated hole guide 46 and the travel of the guide element 72 through the guide track 48 on the holding part 42.

The nozzle supporting parts 62, 64 then assume the angular position depicted in FIG. 4 (in solid lines) and FIG. 5. In the angular position, the nozzle support device 60 has a wedge-like shape in the treatment direction 20. The planes of the air flows 86 of the nozzles 80 are also pivoted relative to each other. The front of drying air formed by the air flows 86 and striking the vehicle 16 is likewise wedge-shaped (FIG. 8). In this way, the air flows 86 can have or form an apex region 90 on the side that is leading with respect to the treatment direction 20. In the apex region 90, the air flows 86 of two nozzles 80, one of which is arranged on each nozzle supporting part 62, 64, overlap each other.

When the drying apparatus 10 is moved in the treatment direction 20, the provision of the front of air flows formed in the shape of a wedge and having the apex region 90 causes liquid to be driven outwardly off the vehicle surface. This gives a better drying result. In particular, splash-back of liquid located in crevices on the vehicle's surface can be largely prevented.

It has proved to be advantageous that, when the nozzle supporting parts 62, 64 are transferred to the angular position, the nozzle supporting parts 62, 64 are not only pivoted relative to the holding parts 40 and 42 respectively, but also displaced towards one another. This ensures that the nozzles 80 will not move away from one another and create a break in the middle of the front of air flows 86 between the nozzle supporting parts 62, 64, as would otherwise occur with pivoting alone of the nozzle supporting parts 62, 64. Rather, the apex region 90 is formed in the angular position of the nozzle supporting parts 62, 64 and also maintained in different angular positions. In addition to the displacement motion of the nozzle supporting parts 62, 64, the coupling device 74 having the joint 76 has also proved to be advantageous in order for this effect to be achieved.

In the drying apparatus 10, different angular positions can be assumed, depending on how far the piston-cylinder unit 56 is extended. For example, it may be provided that, different from what has been described previously, transition areas between vehicle surfaces are passed by the drying apparatus 10 in such a way that the nozzle supporting parts 62, 64 assume a greater angle 88 relative to each other when at the transition area than when at a distance to the transition area.

In particular, the angle 88 can be adjusted depending on the contour of the vehicle 16 by the control device 24 controlling the adjusting device 52 in an appropriate manner.

As mentioned above, the treatment direction 20 can be reversed; details on this will be given below with reference to FIG. 7 in particular. The treatment direction is designated by the reference numeral 20′ in FIG. 7.

When the drying apparatus 10 together with the wash gantry travels in the opposite treatment direction 20′, it is possible to form an apex region 90 also in the treatment direction 20′ when the nozzle supporting parts 62, 64 assume an angular position. The reference numeral 88′ in FIG. 7 indicates the angle between the nozzle supporting parts 62, 64.

When travel occurs in the treatment direction 20′, the piston-cylinder unit 58 is extended in lieu of the piston-cylinder unit 56. The nozzle supporting parts 62, 64 pivot relative to the holding parts 40 and 42 respectively in the opposite direction, as explained above, with simultaneous displacement of the nozzle supporting parts 62, 64 towards each other in the transverse direction in this case as well.

A wedge-like shape of the nozzle support device 60 having a wedge-shaped front of the air flows 86 including the apex region 90 can thereby also be provided for the case of travel in the treatment direction 20′, in order to achieve a better drying result.

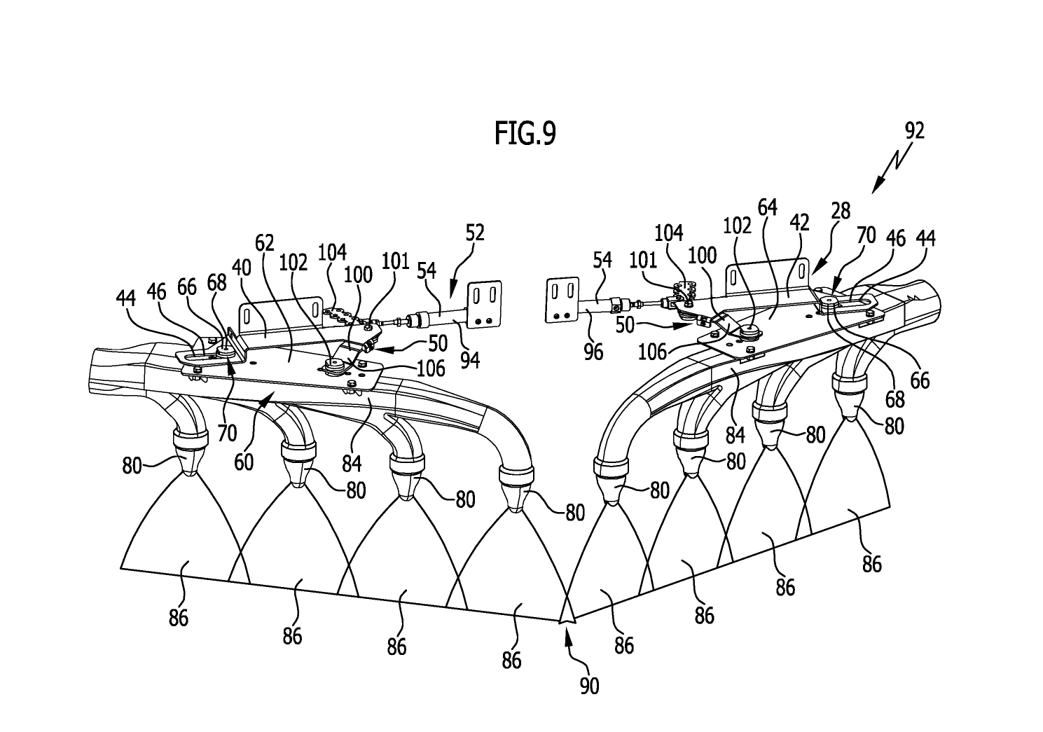

A second advantageous embodiment, illustrated in FIGS. 9 to 11, of a drying apparatus in accordance with the invention is denoted by the reference numeral 92. The drying apparatus 92 is only partially shown with, for example, the vertical beams 30 and the cross beam 32 omitted. Features and component parts which are the same as or functionally equivalent to those illustrated in the drying apparatus 10 are denoted by the same reference numerals.

In the drying apparatus 30, there have been omitted from the constrained guide 50 the guide tracks 48 on the holding parts 40, 42 and also omitted is the coupling device 74.

The adjusting device 52 comprises actuators 54, wherein the holding parts 40, 42 in each case have associated therewith a piston-cylinder unit 94 and 96 respectively. The piston-cylinder units 94, 96 are, at a first end thereof, fixed to a fixing element 98 which is held, as are the holding parts 40, 42, on the cross beam 32 (not illustrated).

The guide elements 72 are omitted from the nozzle supporting parts 62, 64. Instead, each constrained guide 50 has a joint member 100 which is articulated to the holding parts 40, 42 and the nozzle supporting parts 62 and 64 respectively. The respective joints on the holding parts 40, 42 and on the nozzle supporting parts 62, 64 respectively are denoted by the reference numerals 101 and 102 respectively.

The ends of the piston-cylinder units 94, 96 facing away from the fixing elements 98 are fixed to the respective joint member 100. To this end, the respective joint member 100 has a fixing section 104 which in the present case protrudes from the connecting section 106 of the joint member 100 which connects the joints 101, 102. However, it is also conceivable for the piston-cylinder units 94, 96 to engage the connecting section 106 directly and for no fixing section 104 to exist. It may also be provided that, unlike in the drawing, the fixing section 104 lines up with the connecting section 106. In the present case, an angle between the fixing section 104 and the connecting section 106 is approximately 120°.

Predefined at the fixing section 104 are a plurality of different engagement points 108 at which a piston-cylinder unit 94, 96 can engage. This provides a way of predetermining the pivot range of the nozzle supporting part 62, 64 relative to the holding part 40 and 42 respectively, depending on where the piston-cylinder units 94, 96 engage.

Apart from the above, reference may be had to what has been described in the foregoing. A pivotal and displacement movement of the nozzle supporting parts 62, 64 can also be provided in the drying apparatus 92. In an angular position of the nozzle supporting parts 62, 64, which in the present case is defined by the direction of the ducts 84 in particular, an apex region 90 of the air flows 86 can be formed.

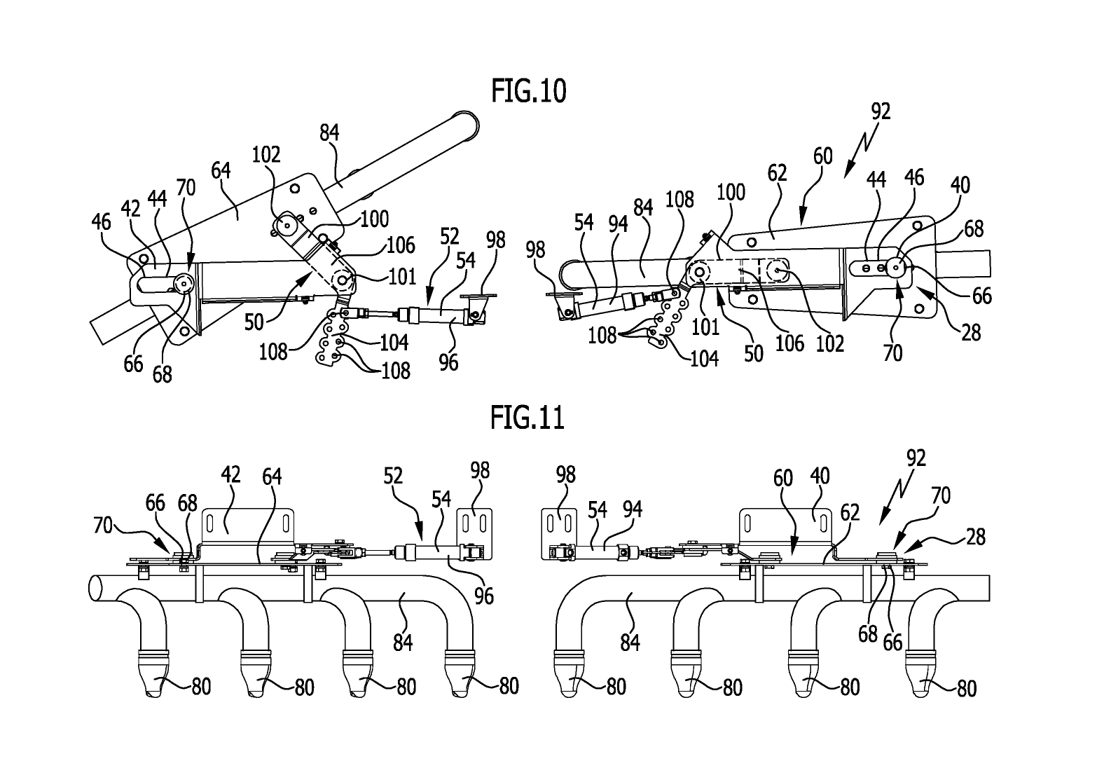

FIGS. 10 and 11 show the drying apparatus 92 in such a way that the nozzle supporting part 64 has now pivoted to the angular position, while the nozzle supporting part 62 is still shown as being in the straight position. It will be understood that this is set forth merely to better explain the invention. In use of the drying apparatus 92, the nozzle supporting parts 62, 64 can jointly and synchronously be pivoted and brought to a straight position or a respective angular position. To this end, the two piston-cylinder units 94, 96 can be controlled by the control device 24.

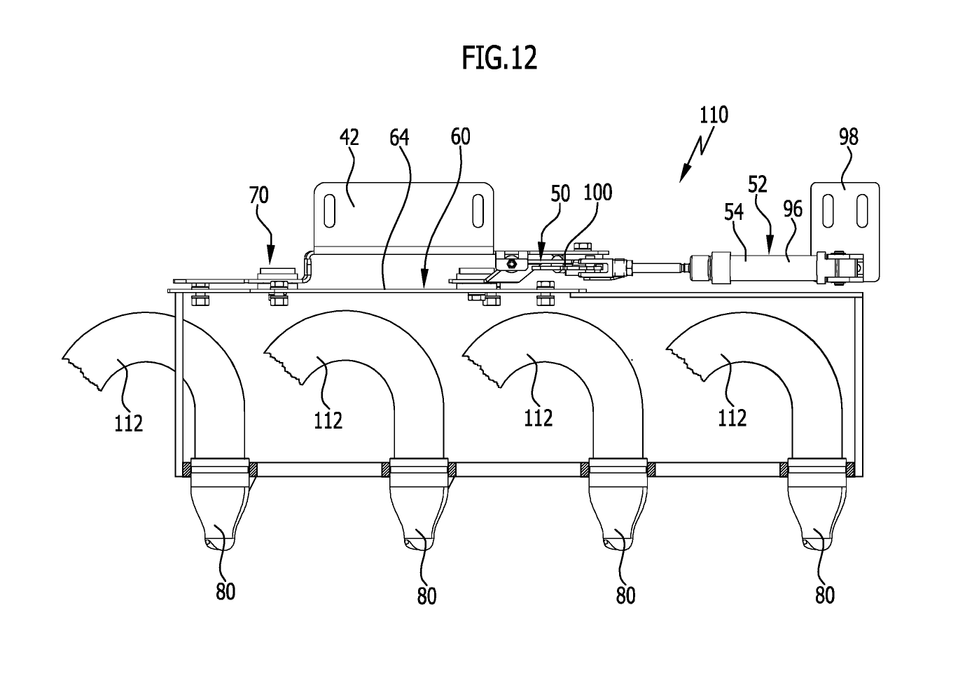

A drying apparatus 110 in accordance with the invention is only partially shown in FIG. 12 with only one holding part 42 and one nozzle supporting part 64 and is of similar construction to the drying apparatus 92. The essential difference is that the nozzles 80 are individually fixed to the nozzle supporting part 64. The nozzles 80 are supplied from respective ducts 112. Each duct 112 can have its own blower 82 associated therewith. It may also be provided for the ducts 112 to join, for example at an outlet side of a common blower 82.

Although not shown for the drying apparatus 110, the corresponding holding part 40 and the corresponding nozzle supporting part 62 have a configuration corresponding to that shown in FIG. 12. The kinematics of the pivotal and displacement movement of the nozzle supporting parts 62, 64 is identical to that for the drying apparatus 92.

In the embodiments of the drying apparatus in accordance with the invention as described in the following, only the essential differences relative to the drying apparatus 10 or 92 will be discussed. The advantages that can be achieved with these can also be achieved here.

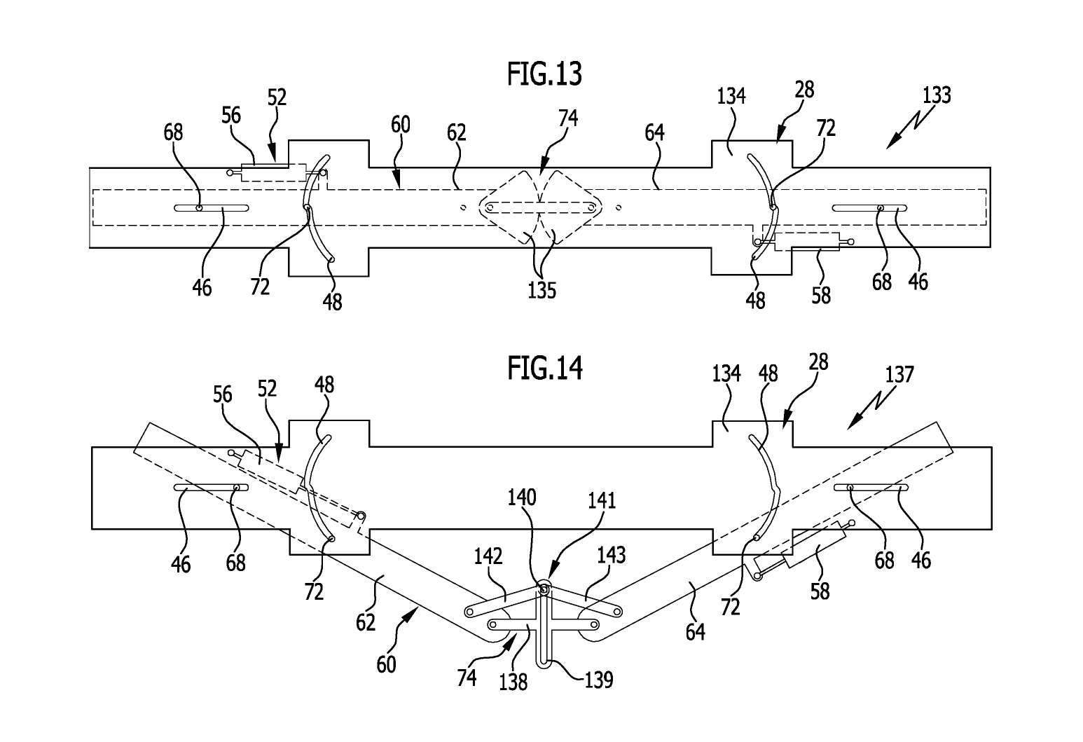

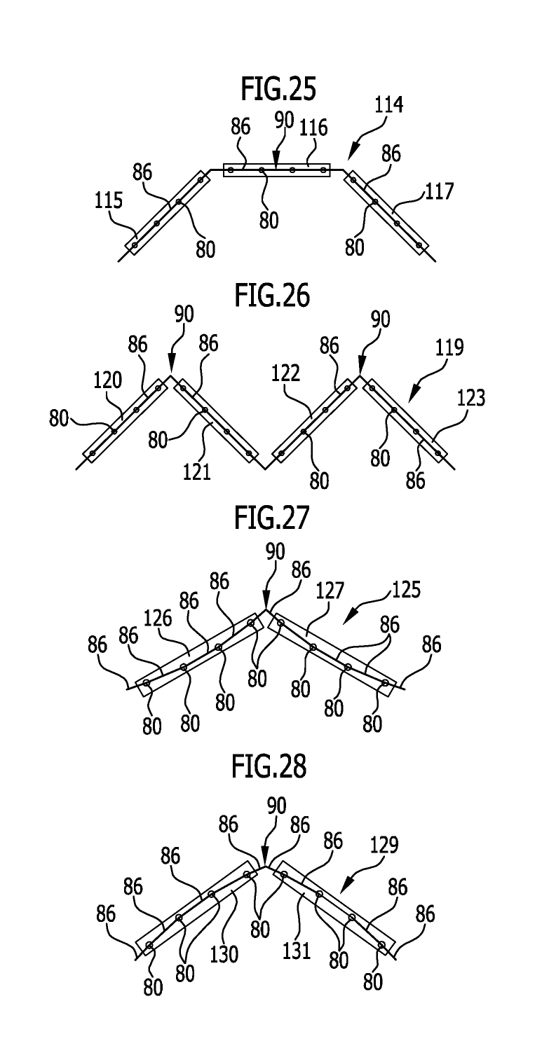

Prior to discussing further construction variants of the holding device 28 and the nozzle support device 60 in FIGS. 13 to 32, reference will first be made to the schematic representations of FIGS. 25 to 28. FIGS. 25 to 28 illustrate nozzle support devices of advantageous embodiments of drying apparatuses in accordance with the invention which are not further illustrated; these are in particular discussed with reference to their nozzle supporting parts and the arrangement of nozzles held thereto.

In the nozzle support device 114 of FIG. 25, three nozzle supporting parts 115, 116 and 117 are provided, each having at least one nozzle 80. When in the angular position, the nozzle supporting parts 115 to 117 are oriented relative to one another such that the nozzle support device presents a trapezoidal shape. The nozzle supporting parts 115, 117 are oriented obliquely with respect to the treatment direction 20, and the nozzle supporting part 116 extends in the transverse direction. As a result, the front of the air flows 86 is also trapezoidal in shape and has a relatively wide apex region 90 by reason of superposition of the air flows 86.

In the nozzle support device 119 of FIG. 26, four nozzle supporting parts 120 to 123 are provided. When in the angular position, the nozzle supporting parts 120 to 123 are positioned in a zigzag arrangement. The air flows 86 form two apex regions 90.

The nozzle support device 125 of FIG. 27 has nozzle supporting parts 126, 127 which can be constructed and moved relative to each other in the same way as the nozzle supporting parts 62, 64 for example. Unlike the drying apparatus 10, the nozzles 80 are positioned at the nozzle supporting parts 126, 127 such that the fronts of the air flows 86 provided by them do not coincide. Instead, the nozzles 80 are attached to the nozzle supporting parts 126, 127 such that the planes of the air flows 86 of adjacent nozzles 80 are in each case inclined at a certain, albeit in the present case small, angle to each other.

In the angular position of the nozzle supporting parts 126, 127, this results in a concave shape, relative to the treatment direction 20, of the air flows 86 on either side of the apex region 90, which is also present in the present case.

A similar solution is shown for the nozzle support device 129 of FIG. 28 having nozzle supporting parts 130, 131. Here, the nozzles 80 are arranged such that the planes of the air flows 86 of adjacent nozzles 80 are inclined, namely at an angle that is small in the present case as well.

As contrasted to the variant of FIG. 27, the nozzles 80 are arranged such that the air flows 86, relative to the treatment direction 20, form a convex shape on either side of the still-present apex region 90.

It will be understood that in particular the arrangement of nozzles 80 as has been described for the nozzle support devices 125, 129 of FIGS. 27 and 28 can also be provided for the drying apparatus 10, the drying apparatus 92, the drying apparatus 110 or any one of the drying apparatuses described hereinafter.

In the drying apparatuses shown in schematic partial representation in FIGS. 13 to 32, the same reference numerals as in the drying apparatus 10 are used. Where only one holding part is provided in lieu of the holding parts 40, 42 (FIGS. 13 to 16, 19, 20), these are given the same reference numeral. The holding part can be formed by the cross beam 32 or by a holding part held thereon, for example.

A drying apparatus 133 shown in FIG. 13 shows the nozzle supporting parts 62, 64 in a straight position and is constructed similar to the drying apparatus 10. One holding part 134 is provided for both nozzle supporting parts 62, 64 and it has the features of the two holding parts 40, 42.

The coupling device 74 comprises, instead of the joint 76, rolling bodies in the form of toothed wheel segments 135 on the end sides of the nozzle supporting parts 62, 64 facing towards the respective other nozzle supporting part 64, 62. Via the rolling, meshing movement of the toothed wheel segments 135, the movement of one nozzle supporting part 62, 64 is transferred to the respective other nozzle supporting part 64, 62 when the adjusting device 52 is activated.

The piston-cylinder unit 56 applies an actuating force to the nozzle supporting part 62, and the piston-cylinder unit 58 can apply an actuating force to the nozzle supporting part 64 when the drying apparatus 133 is moved in the reverse treatment direction 20′.

FIG. 14 illustrates a drying apparatus 137 with the nozzle supporting parts 62, 64 thereof assuming an angular position. The drying apparatus 137 is similar to the drying apparatus 133.

The coupling device 74 comprises a joint member 138 instead of the toothed wheel segments 135. The joint member 138 is articulated to the end sides of the nozzle supporting parts 62, 64 facing towards the respective other nozzle supporting part 64, 62. The joint member 138 forms a guide 139 for a guide element 140, such as a guide pin. The guide element 140 is formed on a joint 141, on which are articulately connected together two joint members 142, 143 which are further articulated to the nozzle supporting parts 62, 64.

The guide tracks 48 of the two drying apparatuses 133 and 137 are essentially C-shaped and have in each case a bend in the center to enable the nozzle supporting parts 62, 64 to assume a defined straight position.

Both drying apparatuses 133, 137 can be used for travelling in the treatment direction 20 as well as in the reverse treatment direction 20′, wherein in each case only a single piston-cylinder unit 56 or 58 is needed for pivoting the nozzle supporting parts 62, 64.

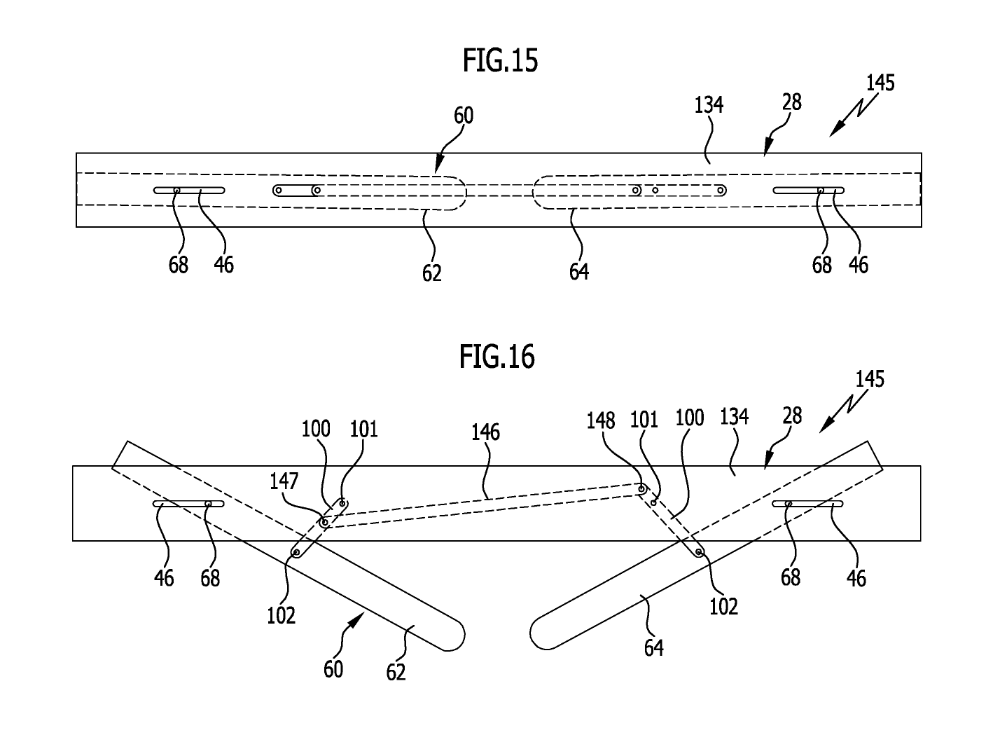

FIGS. 15 and 16 illustrate a drying apparatus denoted by the reference numeral 145, with the nozzle supporting parts 62, 64 thereof being shown as assuming the straight position (FIG. 15) and the angular position (FIG. 16).

The construction of the drying apparatus 145 resembles that of the drying apparatus 92. The constrained guide 50 comprises the joint members 100, wherein the coupling device 74 comprises a joint member 146 which is articulated to the two joint members 100. A joint 147 serves to articulate the joint member 146 between the joints 101 and 102 to a joint member 100. The respective other joint member 100 has provided thereon a joint 148 for articulating the joint member 146 which is arranged outside of the imaginary connection of the joints 101, 102 to each other. The corresponding joint member 100 therefore projects beyond the joint 101.

The drying apparatus 145 is distinguished by particularly slim construction, wherein the spacing of the nozzles 80 relative to one another can be kept constant for maintaining the apex region 90 when in different angular positions.

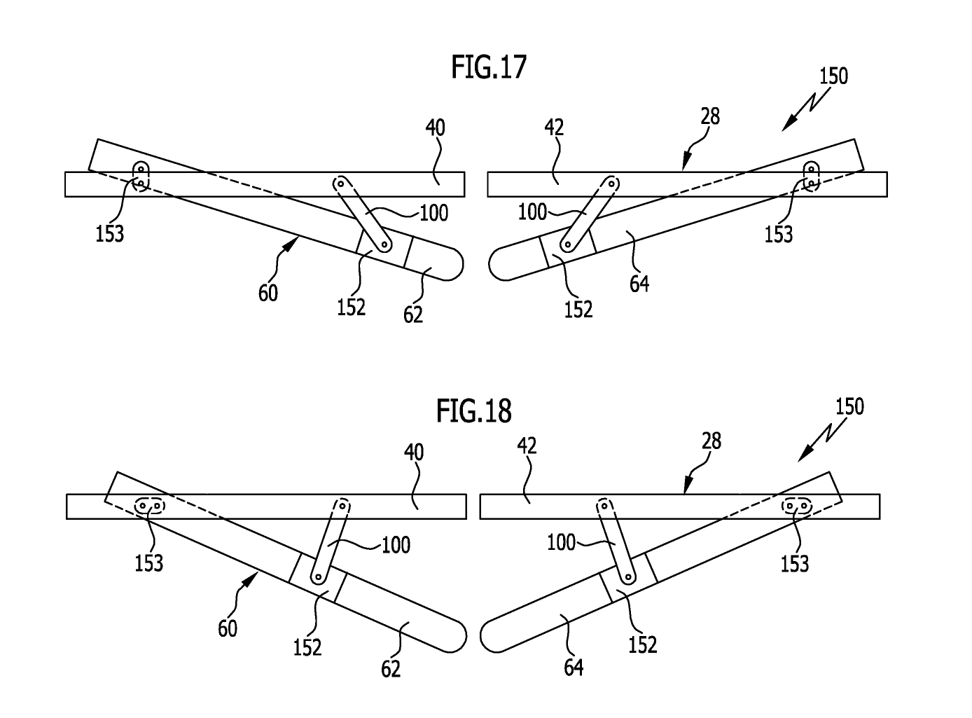

A drying apparatus 150 shown in FIGS. 17 and 18 likewise comprises a constrained guide 50 having joint members 100. However, no spatially invariable joints 102 are formed at the nozzle supporting parts 62, 64. Instead, displacement elements 152 are provided which together with the joint members 100 define the respective joint 102 and can be displaced in the longitudinal direction of the nozzle supporting parts 62, 64.

Instead of the bearing elements 44, 66 and the guide 46 associated therewith, the drying apparatus 150 uses joint members 153 which are articulated to the holding parts 40, 42 and, on the other hand, to the nozzle supporting parts 62 and 64 respectively. The joint members 153 are spaced apart from the joint members 100 in the transverse direction and are of shorter configuration than the joint members 100, wherein they are positioned further towards the outer side of the drying apparatus 150 in the transverse direction.

The holding parts 40, 42, the nozzle supporting parts 62, 64 and the joint members 100 and 153 thereby form four-bar linkages (articulated polygons) of different forms; besides the pivotal movement of the joint members 100, 153, the displacements of the displacement elements 152 also contribute to the change in shape.

The drying apparatus 150 is distinguished by a compact construction and a pivotal movement in both directions in order for the drying apparatus 150 to be capable of being used in both treatment directions 20, 20′. An actuator of the adjusting device 52 can be positioned in a versatile manner. The pivoting of the nozzle supporting parts 62, 64 can be accomplished in a near-parallel manner.

FIGS. 17 and 18 show the nozzle supporting parts 62, 64 in different angular positions, wherein the angle 88 is less in the angular position in FIG. 18 than in the angular position in FIG. 17.

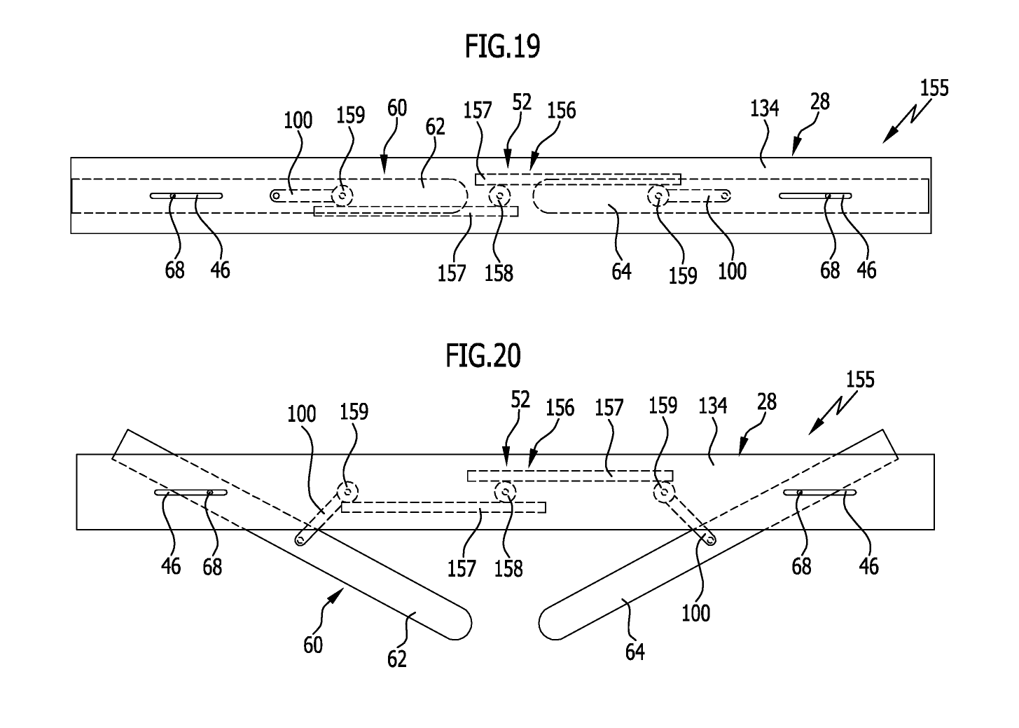

FIGS. 19 and 20 illustrate a drying apparatus designated by the reference numeral 155, with the nozzle supporting parts 62, 64 thereof being shown as assuming a straight position in FIG. 19, whereas FIG. 20 shows an angular position of the nozzle supporting parts 62, 64.

The construction of the drying apparatus 155 resembles that of the drying apparatus 92.

Differently from this, no piston-cylinder units 56, 58 are provided; instead, a rolling drive configured as a rack-and-pinion drive 156 is used which comprises two drive tracks in the form of toothed racks 157 which are supported on the holding part 134 for displacement in the transverse direction. Each nozzle supporting part 62 has a toothed rack 157 associated therewith.

A drive wheel 158 of the adjusting device 52 configured as a toothed wheel drives and displaces both toothed racks 157.

Furthermore, two rolling bodies in the form of toothed wheels 159 are provided, each of which is connected in rotationally fixed relation to the joint member 100 at the joint 101. Upon displacement of the toothed rack 157, the joint member 100 is pivoted for pivoting the respective nozzle supporting part 62, 64.

The drying apparatus 155 permits a pivotal movement of the nozzle supporting parts 62, 64 in both directions and use of the drying apparatus 155 in both treatment directions 20, 20′. Compact construction is possible and it requires just one adjusting device 52 to pivot the nozzle supporting parts 62, 64 in both directions.

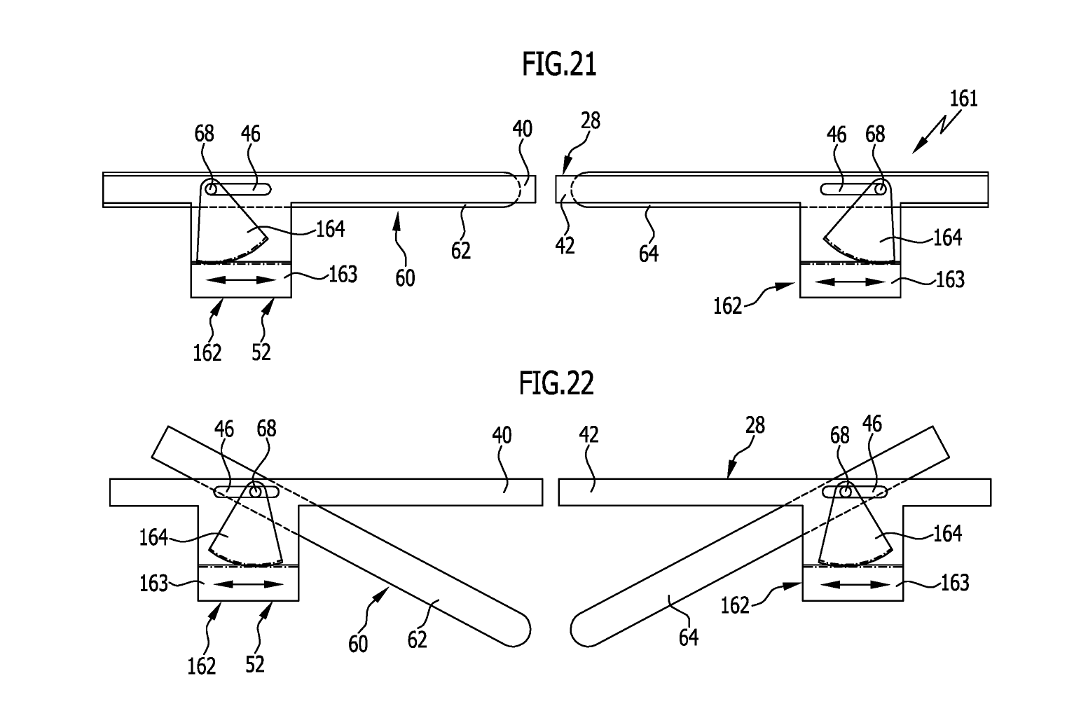

FIGS. 21 and 22 illustrate a drying apparatus denoted by reference numeral 161, with its nozzle supporting parts 62, 64 being shown as assuming the straight position in FIG. 21 and as assuming an angular position in FIG. 22.

The drying apparatus 161 uses features of the drying apparatuses 10 and 92. The constrained guide 50 is omitted, and in place of the piston-cylinder units 56, 58 the adjusting device 52 has rolling drives in the form of rack-and-pinion drives 162, wherein one rack-and-pinion drive 162 is associated with one holding part 40, 42 and one nozzle supporting part 62, 64 in each case.

The rack-and-pinion drive 162 comprises a drive track in the form of a toothed rack 163 which can be displaced on the holding part 40 or 42 and a rolling body in the form of a toothed wheel segment 164 which is connected in rotationally fixed relation to the nozzle supporting part 62 and 64 respectively. The connection is, for example, via the bearing pin 68. The toothed racks 163 can be displaced via a respective further drive element of the adjusting device 52, not shown in the drawing, for pivoting the nozzle supporting parts 62, 64 on the holding parts 40, 42.

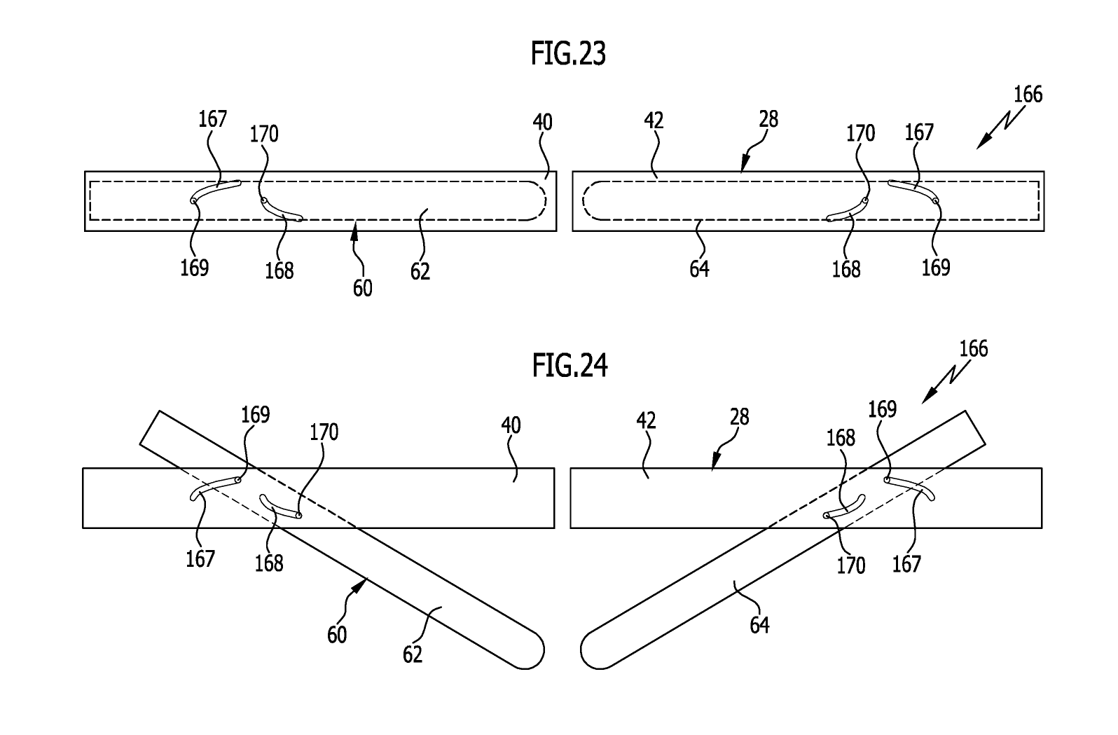

The drying apparatus 161 is simple and rugged in structure. Likewise, a drying apparatus shown in FIGS. 23 and 24 and designated therein by the reference numeral 166 is of particularly simple and rugged construction.

In the drying apparatus 166, two guides 167, 168 of different curvature and arranged in spaced relation to each other are provided on each holding part. The guides 167, 168 are configured as guide tracks.

Arranged on the nozzle supporting parts 62, 64 are respective guide elements 169 and 170 engaging in the guides 167 and 168 respectively. Instead of a pivotal and displacement movement as for example with the drying apparatus 10, the nozzle supporting parts 62, 64 can perform superimposed pivotal movements relative to the holding parts 40 and 42 respectively by way of variable-position pivot bearings.

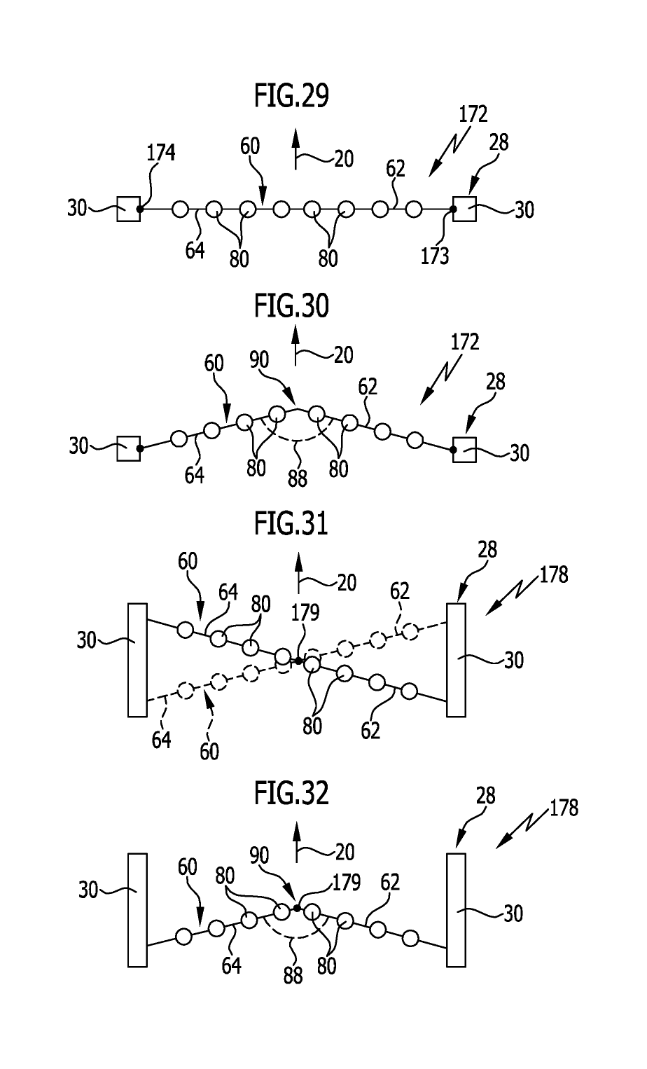

Shown in FIGS. 29 and 30 is an advantageous embodiment of a drying apparatus in accordance with the invention, designated by the reference numeral 172. The same reference numerals are used in the drying apparatus 172 for features and component parts that are the same as or functionally equivalent to those of the drying apparatus 10.

In the drying apparatus 172, the cross beam 32 of the holding device 28 is omitted. The nozzle supporting parts 62, 64 are pivotally connected to the vertical beams 30 of the holding device 28 via joints 173 and 174 respectively. The nozzle supporting parts 62 can be formed by ducts 84, which are not shown in the drawing. In the embodiment illustrated in the drawing, the nozzles 80 are held separately on the nozzle supporting parts 62, 64. It is also conceivable for a duct 84 holding the nozzles 80 on the outlet side thereof to be held to a respective nozzle supporting part 62, 64. These descriptions also apply to the drying apparatus 178 to be described below.

In a straight position of the nozzle supporting parts 62, 64, these are lined up with each other transversely to the treatment direction 20 (FIG. 29). The front of the drying air formed by the air flows 86, not shown in the drawing, is planar.

The nozzle supporting parts 62, 64 can be transferred to a wedge-shaped angular position by pivoting on the vertical beams 30 (FIG. 30). In the angular position of the nozzle supporting parts 62, 64, an apex region 90 is formed on the side that is leading with respect to the treatment direction 20.

It may be provided that, differently from the illustration in FIG. 30, in addition to the nozzle supporting parts 62, 64 being pivoted on the vertical supports 30, they are also displaced relative to the holding device 28, in particular in the transverse direction. As with, for example, the drying apparatus 10, this can prevent the distance between nozzles 80 arranged on the end side of the nozzle supporting parts 62, 64 from being increased as a result of the pivotal movement.

An advantageous embodiment of a drying apparatus in accordance with the invention shown in FIGS. 31 and 32 is denoted by the reference numeral 178. The same reference numerals as in the drying apparatus 10 are used.

In the drying apparatus 178, the cross beam 32 is also omitted. The nozzle supporting parts 62, 64 are held to the vertical beams 30 for movement, in particular displacement, for example parallel to the treatment direction 20. A joint 179 pivotally connects together the nozzle supporting parts 62, 64 to each other at respective ends thereof facing away from the vertical beams 30.

The nozzle supporting parts 62, 64 can assume a straight position in which they line up with each other. Differently from for example the drying apparatus 172, the nozzle supporting parts 62, 64 do not line up transversely but obliquely to the treatment direction 20 and obliquely to the transverse direction. Provision may be made for the nozzle supporting part 64 to be arranged on the drying apparatus 178 on the side that is leading with respect to the treatment direction 20. This corresponds to the solid-line illustration of the nozzle support device 60 in FIG. 31. Alternatively, it is also conceivable for the nozzle supporting part 62 to be arranged on the drying apparatus 178 on the side that is leading in the treatment direction 20. This corresponds to the broken-line arrangement of the nozzle support device 60 of FIG. 31.

By the nozzle support device 60 being oriented obliquely with respect to the treatment direction 20, it is possible for the drying apparatus 178, as a result of it extending diagonally across the vehicle, to blow off cleaning liquid obliquely across the vehicle surface from one side to the other.

The nozzle supporting parts 62, 64 can be transferred to an angular position (FIG. 32). Advantageously, this can be realized by displacing only one of the nozzle supporting parts 62, 64 on the vertical beam 30 while simultaneously pivoting same towards the respective other nozzle supporting part 62, 64 on the joint 179. This is shown in FIG. 32 by the example of a displacement and pivotal movement of the nozzle supporting part 64. In order to effect length compensation between the straight position and the angular position, the nozzle supporting parts 62, 64 can be supported on the cross beams 32 for displacement in the transverse direction or with play.

In the wedge-shaped angular position, the air flows 86 (not illustrated in the drawing) provided by the nozzles 80 of the drying apparatus 178 also form the apex region 90 on the side that is leading in the treatment direction 20.

In the drying apparatuses 172 and 178, the cross beam 32 could also be provided on which the nozzle supporting parts can be movably supported.

FIGS. 1 to 4 show the vehicle wash installation 12 in accordance with the invention in which the drying apparatus 10 is used. It is of course conceivable that any one of the drying apparatuses 92, 110, 133, 137, 145, 155, 161, 166, 172 or 178 described in the foregoing is used in the vehicle wash installation 12 in accordance with the invention.

1. A drying apparatus for motor vehicles for use in a vehicle wash installation, which drying apparatus is movable in a treatment direction relative to the surface of a motor vehicle to be dried, wherein the drying apparatus comprises a plurality of nozzles which are suppliable with drying air and comprises a nozzle support device for the nozzles and a holding device which holds the nozzle support device, wherein the nozzle support device comprises at least two nozzle supporting parts arranged side by side transversely to the treatment direction and at least one nozzle is held directly or indirectly on each nozzle supporting part, and wherein the drying apparatus comprises an adjusting device for moving the at least two nozzle supporting parts on the holding device and transferring the nozzle supporting parts relative to one another between at least two relative positions in which the nozzle supporting parts are oriented at different angles to one another, wherein the two or more relative positions comprise at least one angular position in which air flows exiting the nozzles have or form an apex region on the side that is leading with respect to the treatment direction.

2. The drying apparatus in accordance with claim 1, wherein the drying apparatus is a roof drying apparatus.

3. The drying apparatus in accordance with claim 1, wherein the two or more relative positions comprise a straight position of the nozzle supporting parts in which the nozzle supporting parts line up with each other and the nozzle support device is of a straight-line or substantially straight-line configuration.

4. The drying apparatus in accordance with claim 1, wherein the two or more relative positions comprise a plurality of angular positions in which the nozzle supporting parts are oriented at different angles to one another, wherein air flows exiting the nozzles have or form in each case at least one apex region on the side that is leading with respect to the treatment direction.

5. The drying apparatus in accordance with claim 1, wherein the nozzle supporting parts are transferable continuously or in steps between the two or more relative positions by way of the adjusting device.

6. The drying apparatus in accordance with claim 1, wherein the treatment direction is reversible and wherein, by way of the adjusting device, the nozzle supporting parts are transferable relative to one another between at least two relative positions in which the nozzle supporting parts are oriented at different angles to one another, wherein at least one angular position is provided in which air flows exiting the nozzles have or form an apex region on the side that is leading with respect to the reverse treatment direction.

7. The drying apparatus in accordance with claim 1, wherein the drying apparatus comprises a detection device for detecting the contour of the motor vehicle and a control device coupled to the detection device and to the adjusting device, wherein the nozzle supporting parts assume the at least one angular position depending on the detected contour.

8. The drying apparatus in accordance with claim 7, wherein in a transition area at which surfaces of the motor vehicle meet at an angle, the nozzle supporting parts assume the straight position relative to each other or assume an angular position in which they are oriented to each other at a greater angle than when at a distance from the transition area.

9. The drying apparatus in accordance with claim 1, wherein in the at least one angular position of the nozzle supporting parts, the nozzle support device has a wedge-like shape in the treatment direction.

10. The drying apparatus in accordance with claim 1, wherein the nozzle support device comprises more than two nozzle supporting parts which in the angular position are oriented with respect to each other in such a way that the nozzle support device has a convex or trapezoidal shape in the treatment direction.

11. The drying apparatus in accordance with claim 1, wherein the nozzle support device comprises more than two nozzle supporting parts which in the at least one angular position assume a zigzag arrangement with respect to each other.

12. The drying apparatus in accordance with claim 1, wherein the adjusting device has at least one of a mechanical, electrical, pneumatic and hydraulic configuration.

13. The drying apparatus in accordance with claim 1, wherein the adjusting device comprises at least one piston-cylinder unit which engages the holding device and, directly or indirectly, at least one nozzle supporting part.

14. The drying apparatus in accordance with claim 1, wherein the nozzle supporting parts are configured for at least one of pivotal and displacement movement on the holding device via the adjusting device, wherein corresponding bearing elements of the nozzle supporting parts and of the holding device cooperate.

15. The drying apparatus in accordance with claim 14, wherein a respective pivot bearing formed by the cooperating bearing elements is variably positionable for displacing the nozzle supporting parts relative to one another when the nozzle supporting parts are transferred to the at least one angular position.

16. The drying apparatus in accordance with claim 14, wherein the cooperating bearing elements comprise a bearing pin and a guide therefor, wherein the bearing pin is displaced in the guide when the nozzle supporting parts are pivoted relative to the holding device.

17. The drying apparatus in accordance with claim 14, wherein a respective constrained guide is provided which guides the movement of the nozzle supporting part when the nozzle supporting part is pivoted and displaced relative to the holding device.

18. The drying apparatus in accordance with claim 17, wherein the respective constrained guide comprises a guide track and a guide element engaging therein.

19. The drying apparatus in accordance with claim 18, wherein the guide track is configured in a substantially W or V shape.

20. The drying apparatus in accordance with claim 17, wherein the respective constrained guide comprises a joint member which is articulated to the holding device and to the nozzle supporting part.

21. The drying apparatus in accordance with claim 20, wherein an actuator of the adjusting device engages the joint member and the holding device and is preferably fixable to the joint member in one of a plurality of different predefined positions.

22. The drying apparatus in accordance with claim 14, wherein the drying apparatus comprises a coupling device for coupling the nozzle supporting parts to each other, wherein a movement of one nozzle supporting part relative to the holding device is transferable to the other nozzle supporting part and the latter is also movable relative to the holding device.

23. The drying apparatus in accordance with claim 22, wherein the coupling device comprises a joint connecting the nozzle supporting parts with each other, via which joint the nozzle supporting parts are pivotably connected with each other, preferably wherein the joint is arranged on respective end sides of the nozzle supporting parts facing towards one another.

24. The drying apparatus in accordance with claim 22, wherein the coupling device comprises a rolling body on each of the nozzle supporting parts, which rolling bodies roll on one another when the nozzle supporting parts are pivoted to the at least one angular position, preferably wherein the rolling bodies are arranged on respective end sides of the nozzle supporting parts facing towards one another.

25. The drying apparatus in accordance with claim 22, wherein the coupling device comprises a joint member which is articulated to the nozzle supporting parts, preferably on respective end sides of the nozzle supporting parts facing towards one another.

26. The drying apparatus in accordance with claim 22, wherein the coupling device comprises a joint member which is articulated to joint members of a respective constrained guide, said constrained guide being provided which guides the movement of the nozzle supporting part when the nozzle supporting part is pivoted and displaced relative to the holding device.

27. The drying apparatus in accordance with claim 1, wherein the adjusting device comprises a respective rolling drive for the nozzle supporting parts having a driving track displaceable on the holding device and a rolling body rolling on the driving track and fixed directly or indirectly to the nozzle supporting part.

28. The drying apparatus in accordance with claim 27, wherein the rolling body is connected to a respective joint member of a constrained guide in rotationally fixed relation therewith, said constrained guide being provided which guides the movement of the nozzle supporting part when the nozzle supporting part is pivoted and displaced relative to the holding device.

29. The drying apparatus in accordance with claim 27, wherein the adjusting device comprises a common drive wheel with which both driving tracks associated with the nozzle supporting parts are drivable.

30. The drying apparatus in accordance with claim 1, wherein the nozzle supporting parts are each articulately connected to the holding device via two joint members of different lengths which are articulated to the holding device and to the respective nozzle supporting part in spaced relation to each other.

31. The drying apparatus in accordance with claim 1, wherein the nozzle supporting parts are each pivotably connected to the holding device, wherein two curved guide tracks arranged in spaced relation to one another and guide elements engaging therein are provided for each nozzle supporting part.

32. The drying apparatus in accordance with claim 1, wherein the adjusting device engages only one of the nozzle supporting parts in order to move these relative to the holding device.

33. The drying apparatus in accordance with claim 1, wherein the holding device comprises, associated with a respective nozzle supporting part, a holding part on which the respective nozzle supporting part is movably supported as well as a carrier holding the holding parts.

34. The drying apparatus in accordance with claim 1, wherein the drying apparatus comprises at least one of a lifting device for lifting, relative to the motor vehicle, the holding device having a nozzle support device held thereon and a tilting device for tilting, relative to the motor vehicle, the holding device having a nozzle support device held thereon.

35. The drying apparatus in accordance with claim 1, wherein the nozzles are or comprise at least one of the following:
flat jet nozzles which form an air flow that spreads out in a fan shape in substantially one plane;
circular jet nozzles which form a cylindrical, hollow-cylindrical, cone shaped, truncated cone or hollow cone shaped air flow;
slotted nozzles, wherein exactly one slotted nozzle can be provided on each nozzle supporting part;
nozzles which form an air flow in a curved surface area.

36. The drying apparatus in accordance with claim 1, wherein a plurality of nozzles are held on each of the nozzle supporting parts, which nozzles are in particular arranged side by side next to one another on the nozzle supporting part.

37. The drying apparatus in accordance with claim 36, wherein the nozzles are arranged on the nozzle supporting parts such that in the at least one angular position thereof, the air flows form a convex or concave shape in the treatment direction.

38. The drying apparatus in accordance with claim 36, wherein the plurality of nozzles are at least one of flat jet nozzles and circular jet nozzles.

39. The drying apparatus in accordance with claim 36, wherein the plurality of nozzles are held separately from one another on the nozzle supporting part and are suppliable with drying air by a blower device of the drying apparatus via respective ducts.

40. The drying apparatus in accordance with claim 36, wherein a duct for drying air is held on a respective nozzle supporting part or wherein the respective nozzle supporting part comprises such a duct or is formed by a duct which has the plurality of nozzles on the outlet side thereof and is suppliable with drying air at an inlet side thereof by a blower device.

41. The drying apparatus in accordance with claim 1, wherein the drying apparatus comprises a blower device having at least one blower which supplies the nozzles with drying air.

42. The drying apparatus in accordance with claim 41, wherein the blower device comprises a blower which has two or more nozzles associated therewith or wherein each nozzle has a separate blower of the blower device associated therewith.

43. The drying apparatus in accordance with claim 41, wherein the blower device is held to the holding device and is at least one of adjustable in height and tiltable about an axis transverse to the treatment direction together with the holding device.

44. The drying apparatus in accordance with claim 1, wherein each nozzle supporting part has arranged thereon a slotted nozzle extended in the longitudinal direction thereof

45. The drying apparatus in accordance with claim 34, wherein the drying apparatus comprises a detection device for detecting the contour of the motor vehicle and a control device coupled to the detection device and to the lifting device, wherein the drying apparatus can be brought to a distance from the surface of the motor vehicle at which air flows of the nozzles superimpose one another above the surface.

46. The drying apparatus in accordance with claim 1, wherein the nozzle supporting parts and the nozzles held thereto are symmetrically configured relative to one another and arranged on the drying apparatus.

47. The drying apparatus in accordance with claim 1, wherein a circular jet nozzle is arranged on at least one nozzle supporting part on a side thereof facing towards an adjacent nozzle supporting part so that in the angular position of the nozzle supporting parts at least one air flow from a circular jet nozzle can be provided in the apex region.

48. The drying apparatus in accordance with claim 1, wherein nozzles are held to a respective nozzle supporting part in a variably positionable manner.

49. The drying apparatus in accordance with claim 1, wherein adjacent nozzle supporting parts are connected together for at least one of pivotal movement and displacement on a joint.

50. A vehicle wash installation, comprising at least one drying apparatus for motor vehicles, the drying apparatus being movable in a treatment direction relative to the surface of a motor vehicle to be dried, wherein the drying apparatus comprises a plurality of nozzles which are suppliable with drying air and comprises a nozzle support device for the nozzles and a holding device which holds the nozzle support device, wherein the nozzle support device comprises at least two nozzle supporting parts arranged side by side transversely to the treatment direction and at least one nozzle is held directly or indirectly on each nozzle supporting part, and wherein the drying apparatus comprises an adjusting device for moving the at least two nozzle supporting parts on the holding device and transferring the nozzle supporting parts relative to one another between at least two relative positions in which the nozzle supporting parts are oriented at different angles to one another, wherein the two or more relative positions comprise at least one angular position in which air flows exiting the nozzles have or form an apex region on the side that is leading with respect to the treatment direction.
